(19) United States
(12) Patent Application Publication
(10) Pub. No.: US 2026/0199874 A1
(43) Pub. Date: Jul. 16, 2026

(54) CHROMATOGRAPHIC MATERIALS INCLUDING CROSSLINKED STREPTAVIDIN AND BIOTIN AND METHODS OF USE THEREOF

(71) Applicant: Waters Technologies Corporation, Milford, MA (US)

(72) Inventors: Beatrice Muriithi, Atteboro, MA (US); Yeliz Tunc Sarisozen, Westford, MA (US); Nathan Canniff, Concord, MA (US); Martin Gilar, Franklin, MA (US); Kevin Wyndham, Worcester, MA (US)

(73) Assignee: Waters Technologies Corporation, Milford, MA (US)

(21) Appl. No.: 19/449,056

(22) Filed: Jan. 14, 2026

Related U.S. Application Data
(60) Provisional application No. 63/745,002, filed on Jan. 14, 2025.

(51) Int. Cl. B01J 20/26; B01D 15/22; B01D 15/38; B01J 20/289; B01J 20/32

(52) U.S. Cl. CPC B01J 20/267; B01D 15/22; B01D 15/3823; B01J 20/289; B01J 20/321; B01J 20/3219; B01J 20/3244

(57) ABSTRACT

Disclosed herein are chromatographic materials comprising crosslinked streptavidin particles. The crosslinked streptavidin particles are bound to a biotinylated affinity agent and free biotin. The combined impact of streptavidin crosslinking and binding free biotin to accessible binding sites in streptavidin drastically reduce leaching of streptavidin from the chromatographic materials. The chromatographic materials disclosed herein may be used to prepare affinity chromatographic columns.

### CROSS-REFERENCE TO RELATED APPLICATION

This application claims priority from and the benefit of U.S. Application No. 63/745,002 filed on Jan. 14, 2025. The entire contents of this application are incorporated herein by reference.

### FIELD OF TECHNOLOGY

The present disclosure generally relates to chromatographic materials including crosslinked streptavidin, biotinylated affinity agents, and free biotin; methods of preparing such materials; methods of preparing chromatography columns including said materials; and methods of using said materials and chromatography columns.

### BACKGROUND

Streptavidin is used in affinity chromatography applications due to its strong non-covalent bond with biotin and biotinylated molecules. Streptavidin occurs as a homotetramer with four binding pockets that bind to biotin (or a biotinylated molecule). The streptavidin tetramer is increasingly stabilized by binding of each of the four binding sites; however, in the absence of said binding, the streptavidin tetramer is susceptible to dissociation under harsh conditions such as high temperatures, strong denaturants, or low pH. This dissociation releases streptavidin monomers, streptavidin leachate, which can interfere with protein-protein interactions, data analysis and overall sample quality. Accordingly, there exists a need in the art for methods of reducing streptavidin leachate from materials for affinity chromatography.

### SUMMARY OF TECHNOLOGY

The present technology provides streptavidin-conjugated chromatographic materials, such as particles, that result in reduced streptavidin leachate. The materials of the present technology include crosslinked streptavidin, a biotinylated affinity agent, and free biotin (i.e., “biotin endcapped crosslinked streptavidin-conjugated materials”). The materials described herein may be used in a column chromatography experiment (e.g., as an affinity chromatography material).

Accordingly, in one aspect, disclosed herein is an affinity chromatography material including (a) a particle including a polymer core and a surface material on an outer layer of the polymer core; (b) a crosslinked streptavidin molecule conjugated to the surface material, wherein the crosslinked streptavidin molecule include a streptavidin molecule and a crosslinking moiety; (c) a biotinylated affinity agent; and (d) free biotin. The biotinylated affinity agent and free biotin are bound to binding sites of the one or more streptavidin molecules.

In some embodiments, at least 90% of accessible binding sites of the crosslinked streptavidin molecules are bound to the biotinylated affinity agent or free biotin. In some embodiments, at least 95% of accessible binding sites of the crosslinked streptavidin molecules are bound with the biotinylated affinity agent or free biotin. In some embodiments, the molar ratio of biotinylated affinity agent to free biotin bound to the crosslinked streptavidin binding sites is a 1:1 molar ratio, a 1:3 molar ratio, a 1:5 molar ratio, a 1:8 molar ratio, a 1:10 molar ratio, a 1:15 molar ratio, a 1:20 molar ratio, a 1:25 molar ratio, a 1:30 molar ratio, a 1:35 molar ratio, a 1:40 molar ratio, a 1:45 molar ratio, or a 1:50 molar ratio.

In some embodiments, the polymer core of the particle is nonporous, the surface material is hydrophilic, and the diameter of the particle is from 1.0 μm to 10 μm. In some embodiments, the non-porous polymer core has a gradient composition. In some embodiments, the polymer core includes divinylbenzene monomers and styrene monomers. In some embodiments, the hydrophilic surface is selected from the group consisting of: (3-glycidyloxypropyl) trimethoxysilane, (3-glycidyloxypropyl)triethoxysilane, polyacrylate, glycidol, glyceroltriglycidyl ether, and poly(methyl acrylate).

In some embodiments, the crosslinked streptavidin molecule is conjugated to the hydrophilic surface via an epoxy linker. In some embodiments, the epoxy linker has a formula of

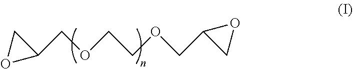

wherein n is between 1-12. In some embodiments, n is 1, 4, or 9. In some embodiments, n is 1. In some embodiments, the affinity chromatography material includes a plurality of crosslinked streptavidin molecules, wherein each crosslinked streptavidin molecule is conjugated to the surface material of the particle. In some embodiments, the plurality of crosslinked streptavidin molecules conjugated to the surface material provide a surface coverage on the particle of from about 2 μg/mg of particle to about 6 μg/mg of particle.

In some embodiments, the crosslinking moiety is ethylene glycol diglycidyl ether or a poly(ethylene glycol) diglycidyl ether. In some embodiments, the crosslinking moiety is ethylene glycol diglycidyl ether. In some embodiments, the crosslinking moiety is a poly(ethylene glycol) diglycidyl ether including m ethylene oxide units, wherein m is from 1 to 50. In some embodiments, m is 2, 9, or 22.

In a second aspect, disclosed herein is an affinity chromatography column including the affinity chromatography material of the first aspect. The affinity chromatography column may include any other appropriate component known in the art, such as a column body with an interior surface or a frit. In some embodiments, at least a portion of an interior surface of the column body is coated with an alkylsilyl material. In some embodiments, the column further includes frits within the column body, wherein the frits are coated with the alkylsilyl material. In some embodiments, the alkylsilyl material is a hydrophilic, non-ionic layer of polyethylene glycol silane.

In some embodiments, the column is characterized by a reduction in detectable leachate of streptavidin as determined by UV absorbance. In some embodiments, the column is characterized by a leachate absorbance value of <10 mAU as measured by UV absorbance at 280 nm. In some embodiments, the column is characterized by at least an 85% reduction in leachate absorbance as compared to a column that does not include crosslinked streptavidin. In some embodiments, the column is characterized by at least an 85% reduction in leachate absorbance as compared to a column that does not include the biotinylated affinity agent and free biotin. In some embodiments, the column is characterized by at least an 85% reduction in leachate absorbance as compared to a column that does not include crosslinked streptavidin, the biotinylated affinity agent, and free biotin. In some embodiments, the column has at least a 90% reduction or at least a 95% reduction in leachate absorbance. In some embodiments, the column is characterized by no detectable leachate of streptavidin as determined by UV absorbance. In some embodiments, leachate absorbance is determined at the 4th peak eluted from the column as measured by UV absorbance at 280 nm.

In a third aspect, disclosed herein is an affinity chromatographic column including a column body formed of a metal or a metal alloy, a plurality of crosslinked streptavidin-conjugated particles housed within the column body, wherein a biotinylated affinity agent and free biotin are bound to accessible binding sites of the crosslinked streptavidin molecules. In some embodiments, at least 90% of accessible binding sites of the crosslinked streptavidin molecules are bound to the biotinylated affinity agent or free biotin. In some embodiments, at least 95% of accessible binding sites of the crosslinked streptavidin molecules are bound with the biotinylated affinity agent or free biotin.

In some embodiments, the molar ratio of biotinylated affinity agent to free biotin bound to the crosslinked streptavidin binding sites is a 1:1 molar ratio, a 1:3 molar ratio, a 1:5 molar ratio, a 1:8 molar ratio, a 1:10 molar ratio, a 1:15 molar ratio, a 1:20 molar ratio, a 1:25 molar ratio, a 1:30 molar ratio, a 1:35 molar ratio, a 1:40 molar ratio, a 1:45 molar ratio, or a 1:50 molar ratio.

In some embodiments, each of the plurality of crosslinked streptavidin-conjugated particles includes a polymer core, a surface material on the outer surface of the polymer core, and one or more crosslinked streptavidin molecules; wherein each crosslinked streptavidin molecule includes a streptavidin molecule and a crosslinking moiety.

In some embodiments, the polymer core of the particle is nonporous, the surface material is hydrophilic, and the diameter of the particle is from 1.0 μm to 10 μm. In some embodiments, the non-porous polymer core has a gradient composition. In some embodiments, the nonporous polymer core includes divinylbenzene monomers and styrene monomers. In some embodiments, the hydrophilic surface is from the group consisting of: (3-selected glycidyloxypropyl) trimethoxysilane, (3-glycidyloxypropyl)triethoxysilane, polyacrylate, glycidol, glyceroltriglycidyl ether, and poly(methyl acrylate).

In some embodiments, the crosslinked streptavidin molecule is conjugated to the hydrophilic surface via an epoxy linker. In some embodiments, the epoxy linker has a formula of

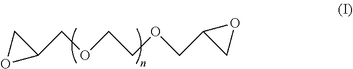

wherein n is between 1-12. In some embodiments, n is 1, 4, or 9. In some embodiments, n is 1. In some embodiments, the plurality of crosslinked streptavidin molecules conjugated to the surface material provide a surface coverage on the particle of from about 2 μg/mg of particle to about 6 μg/mg of particle.

In some embodiments, the crosslinking moiety is ethylene glycol diglycidyl ether or a poly(ethylene glycol) diglycidyl ether. In some embodiments, the crosslinking moiety is ethylene glycol diglycidyl ether. In some embodiments, the crosslinking moiety is a poly(ethylene glycol) diglycidyl ether including m ethylene oxide units, wherein m is from 1 to 50. In some embodiments, m is 2, 9, or 22.

In some embodiments, at least a portion of an interior surface of the column body is coated with an alkylsilyl material. In some embodiments, the affinity chromatography column further includes frits within the column body, wherein the frits are coated with the alkylsilyl material. In some embodiments, the alkylsilyl material is a hydrophilic, non-ionic layer of polyethylene glycol silane.

In some embodiments, the column is characterized by a reduction in detectable leachate of streptavidin as determined by UV absorbance. In some embodiments, the column is characterized by a leachate absorbance value of <10 mAU as measured by UV absorbance at 280 nm. In some embodiments, the column is characterized by at least an 85% reduction in leachate absorbance as compared to a column that does not include crosslinked streptavidin. In some embodiments, the column is characterized by at least an 85% reduction in leachate absorbance as compared to a column that does not include the biotinylated affinity agent and free biotin. In some embodiments, the column is characterized by at least an 85% reduction in leachate absorbance as compared to a column that does not include crosslinked streptavidin, the biotinylated affinity agent, and free biotin. In some embodiments, the column has at least a 90% reduction in leachate absorbance. In some embodiments, the column has at least a 95% reduction in leachate absorbance. In some embodiments, the column is characterized by no detectable leachate of streptavidin as determined by UV absorbance. In some embodiments, the leachate absorbance is determined at the 4th peak eluted from the column as measured by UV absorbance at 280 nm.

In a fourth aspect, disclosed herein is a method of forming an affinity chromatographic material, the method including: (a) providing a streptavidin-conjugated particle including a polymer core, a surface material on the outer surface of the polymer core, and one or more streptavidin molecules conjugated to the surface material; (b) contacting the streptavidin-conjugated particle with a crosslinking moiety, thereby crosslinking the streptavidin molecules and forming a crosslinked streptavidin-conjugated particle; (c) contacting the crosslinked streptavidin-conjugated particle with a solution including a biotinylated affinity agent, thereby binding the biotinylated affinity agent to the accessible binding sites of the crosslinked streptavidin molecules; and (d) contacting the crosslinked streptavidin-conjugated particle with a solution including free biotin; thereby binding free biotin to the accessible binding sites of the crosslinked streptavidin molecules.

In a fifth aspect, disclosed herein is a method of forming an affinity chromatographic material, the method including: (a) crosslinking a plurality of streptavidin molecules with a crosslinking moiety, thereby forming a plurality of crosslinked streptavidin molecules; (b) conjugating the plurality of crosslinked streptavidin molecules to a particle, the particle including a polymer core and a surface material on the outer surface of the polymer core, wherein the crosslinked streptavidin molecules are conjugated to the surface material, thereby forming a crosslinked streptavidin-conjugated particle; (c) contacting the crosslinked streptavidin-conjugated particle with a solution including a biotinylated affinity agent, thereby binding the biotinylated affinity agent to the accessible binding sites of the crosslinked streptavidin molecules; and (d) contacting the crosslinked streptavidin-conjugated particle with a solution including free biotin; thereby binding free biotin to the accessible binding sites of the crosslinked streptavidin molecules.

In some embodiments of the fourth or fifth aspect, steps (c) and (d) are performed simultaneously by contacting the crosslinked streptavidin-conjugated particle with a mixture of the biotinylated affinity agent and free biotin. In some embodiments, the molar ratio of biotinylated affinity agent to free biotin in the mixture is a 1:1 molar ratio, a 1:3 molar ratio, a 1:5 molar ratio, a 1:8 molar ratio, a 1:10 molar ratio, a 1:15 molar ratio, a 1:20 molar ratio, a 1:25 molar ratio, a 1:30 molar ratio, a 1:35 molar ratio, a 1:40 molar ratio, a 1:45 molar ratio, or a 1:50 molar ratio.

In some embodiments, the molar ratio of biotinylated affinity agent to free biotin bound to the binding sites of the crosslinked streptavidin molecules is a 1:1 molar ratio, a 1:3 molar ratio, a 1:5 molar ratio, a 1:8 molar ratio, a 1:10 molar ratio, a 1:15 molar ratio, a 1:20 molar ratio, a 1:25 molar ratio, a 1:30 molar ratio, a 1:35 molar ratio, a 1:40 molar ratio, a 1:45 molar ratio, or a 1:50 molar ratio.

In some embodiments, the polymer core of the particle is nonporous, the surface material is hydrophilic, and the diameter of the particle is from 1.0 μm to 10 μm. In some embodiments, the non-porous polymer core has a gradient composition. In some embodiments, the polymer core includes divinylbenzene monomers and styrene monomers. In some embodiments, the hydrophilic surface is selected from the group consisting of: (3-glycidyloxypropyl) trimethoxysilane, (3-glycidyloxypropyl)triethoxysilane, polyacrylate, glycidol, glyceroltriglycidyl ether, and poly(methyl acrylate).

In some embodiments, the streptavidin molecules are each attached to the hydrophilic surface via an epoxy linker on the hydrophilic surface. In some embodiments, the epoxy linker has a formula of

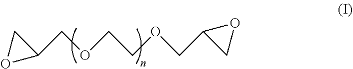

wherein n is between 1-12. In some embodiments, n is 1, 4, or 9. In some embodiments, n is 1. In some embodiments, the surface coverage of the plurality of crosslinked streptavidin molecules conjugated to the surface material of the particle after step (b) is from about 2 μg/mg of particle to about 6 μg/mg of particle.

In some embodiments, the crosslinking moiety is ethylene glycol diglycidyl ether or a poly(ethylene glycol) diglycidyl ether. In some embodiments, the crosslinking moiety is ethylene glycol diglycidyl ether. In some embodiments, the crosslinking moiety is a poly(ethylene glycol) diglycidyl ether including m ethylene oxide units, wherein m is from 1 to 50. In some embodiments, m is 2, 9, or 22.

The material of the fourth or the fifth aspect may be used in a chromatography column. In some embodiments, an affinity chromatography column utilizing the chromatographic material is characterized by a leachate absorbance value of <10 mAU as measured by UV absorbance at 280 nm. In some embodiments, an affinity chromatography column utilizing the chromatographic material is characterized by at least an 85% reduction in leachate absorbance as compared to a column that does not include crosslinked streptavidin. In some embodiments, an affinity chromatography column utilizing the chromatographic material is characterized by at least an 85% reduction in leachate absorbance as compared to a column that does not include the biotinylated affinity agent and free biotin. In some embodiments, an affinity chromatography column utilizing the chromatographic material is characterized by at least an 85% reduction in leachate absorbance as compared to a column that does not include crosslinked streptavidin, the biotinylated affinity agent, and free biotin. In some embodiments, the column has at least a 90% in leachate reduction.

In some embodiments, the column has at least a 95% reduction in leachate absorbance. In some embodiments, the column is characterized by no detectable leachate of streptavidin as determined by UV absorbance. In some embodiments, leachate absorbance is determined at the 4th peak eluted from the column as measured by UV absorbance at 280 nm.

### BRIEF DESCRIPTION OF THE DRAWINGS

The technology will be more fully understood from the following detailed description taken in conjunction with the accompanying drawings, in which:

FIG. 1A-1B are graphical illustrations of methods of preparing crosslinked streptavidin-conjugated chromatographic materials. FIG. 1A depicts a method wherein the streptavidin is crosslinked prior to conjugation to the chromatographic material. FIG. 1B depicts a method wherein the streptavidin is crosslinked after conjugation to the chromatographic material.

FIG. 2 depicts the effect of crosslinker length (n=1, ethylene glycol diglycidyl ether; n=9 poly(ethylene glycol) diglycidyl ether; and n=22 poly(ethylene glycol) diglycidyl ether) on the properties of the resulting streptavidin, compared to free streptavidin (top) and a BEH 200 standard (bottom). The shortest crosslinker examined (n=1) exhibited the least peak broadening and was the least shifted compared to unbound streptavidin.

FIG. 3A-3B depict the reduction in leachate observed with crosslinked streptavidin-conjugated particles. FIG. 3A shows a chromatogram of the eluate from particles including crosslinked streptavidin. FIG. 3B shows a chromatogram of the eluate from particles including streptavidin (non-crosslinked).

FIG. 4A shows a chromatogram for a crosslinked streptavidin molecule.

FIG. 4B shows a chromatogram for a streptavidin molecule which is endcapped with biotin.

FIG. 4C shows a chromatogram for free streptavidin.

FIG. 4D shows a chromatogram for a BEH 200 standard.

FIG. 4E shows a mass spectra of the eluent from a column including non-conjugated streptavidin particles. Masses corresponding to both the polymer particle and streptavidin monomers are observed.

FIG. 4F shows the total ion mass spectra (TIC MS) for the eluate from a column including non-conjugated streptavidin particles.

FIG. 4G shows the detection of ions having a mass of about 677.47 Da (indicative of the polymer) for the eluate from a column including non-conjugated streptavidin particles.

FIG. 4H shows the detection of ions having a mass of about 1328.03 Da (indicative of streptavidin monomers) for the eluate from a column including non-conjugated streptavidin particles.

FIG. 4I shows a mass spectra of the eluent from a column including conjugated streptavidin particles. Masses corresponding to the polymer particle are observed, but no signals corresponding to streptavidin monomers are observed.

FIG. 4J shows the TIC MS for the eluate from a column including conjugated streptavidin particles.

FIG. 4K shows a base peak intensity mass spectra (BPI MS) for the eluate from a column including conjugated streptavidin particles.

FIG. 4L shows the UV-Vis spectroscopy signal from 210 nm to 400 nm for the eluate from a column including conjugated streptavidin particles.

FIG. 4M shows the mass spectra of the hydrophilic section of the polymer particle. The mass spectra shows several distinct peaks characteristic of the polymer.

FIG. 4N shows the detection of ions having a mass of about 625.38 Da (indicative of the polymer) for the eluate from a column including non-conjugated streptavidin particles.

FIG. 4O shows the detection of ions having a mass of about 581.36 Da (indicative of the polymer) for the eluate from a column including non-conjugated streptavidin particles.

FIG. 4P shows the detection of ions having a mass of about 537.33 Da (indicative of the polymer) for the eluate from a column including non-conjugated streptavidin particles.

FIG. 4Q shows the detection of ions having a mass of about 493.31 Da (indicative of the polymer) for the eluate from a column including non-conjugated streptavidin particles.

FIG. 4R shows the detection of ions having a mass of about 449.28 Da (indicative of the poler) for the eluate from a column including non-conjugated streptavidin particles.

FIGS. 5A-5C depict the ability for biotin to bind to accessible binding sites in particles of the present disclosure. FIG. 5A shows the elution of D-biotin from a column including crosslinked streptavidin-conjugated particles. FIG. 5B shows the elution of D-biotin from a column including streptavidin-conjugated particles (no crosslinking). FIG. 5C provides a quantification of the total amount of coupled biotin in each experiment.

FIGS. 6A-6B depict the ability for a biotinylated anti-insulin antibody to bind to accessible binding sites in crosslinked streptavidin-conjugated particles and streptavidin-conjugated particles. FIG. 6A provides the amount coupled over time as measured by the number of injections.

FIG. 6B provides a quantification of the total amount of coupled antibody.

FIGS. 7A-7B depict the ability for a biotinylated anti-AAVX nanobody to bind to accessible binding sites in crosslinked streptavidin-conjugated particles (FIG. 7A) and streptavidin-conjugated particles (FIG. 7B).

FIGS. 8A-8B depict the ability for biotin to bind to a column including crosslinked streptavidin-conjugated particles (FIG. 8A) compared to a column including crosslinked streptavidin-conjugated particles treated with a biotinylated affinity agent (FIG. 8B). The column was run with a solution of 0.1 M of phosphate buffered saline (PBS; pH 7.4) and 1 nmol/μL of biotin at a flow rate of 0.25 mL/min and an injection volume of 2 μL every 2 min. Without the biotinylated affinity agent, biotin saturation was observed after 11 injections (approximately 22 minutes); whereas the column biotinylated affinity agent was saturated with biotin after 10 injections (approximately 20 minutes).

### DETAILED DESCRIPTION

Disclosed herein are methods for preparing biotin endcapped crosslinked streptavidin-conjugated chromatographic materials, such as particles and methods of use thereof. In order that the technology may be more readily understood, certain terms are first defined. In addition, it should be noted that whenever a value or range of values of a parameter are recited, it is intended that values and ranges intermediate to the recited values are also part of this disclosure. The word “about” if not otherwise defined means+5%. It is also to be noted that as used herein and in the claims, the singular forms “a,” “an,” and “the” include plural references unless the context clearly dictates otherwise.

### Definitions

As used herein, the term “antibody” refers to an immunoglobin molecule that specifically binds to, or is immunologically reactive with, a particular antigen. This includes polyclonal, monoclonal, genetically engineering, and otherwise modified forms of antibodies, including but not limited to chimeric antibodies, camelids, monobodies, humanized antibodies, heteroconjugate antibodies (e.g., bi-, tri-, and quad-specific antibodies, diabodies), and antigen-binding fragments of antibodies, including, for example, Fab′, F(ab′)2, Fab, Fv, and scFv fragments. Unless otherwise indicated, the term “monoclonal antibody” is meant to include both intact molecules as well as antibody fragments that are capable of specifically binding to a target protein. As used herein, the Fab and F(ab′)2 fragments refer to antibody fragments that lack the Fc portion of an intact antibody. A single domain antibody may be referred to as a “nanobody” herein.

As used herein, the term “antigen-binding fragment” refers to one or more fragments of an antibody that retain the ability to specifically bind to a target antigen. The antigen-binding function of an antibody can be performed by fragments of a full-length antibody. The antibody fragments can be, for example, a Fab, F(ab′)2, scFv, a camelid, an affibody, a nanobody, an aptamer, or a domain antibody.

As used herein, the term “bispecific antibody” refers to an antibody that is capable of binding at least two different antigens.

As used herein, the term “biotin” (also referred to as “vitamin B7”, and “vitamin H”) refer to the molecule

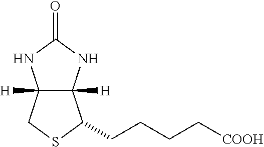 [SMILES: O=C(O)CCCC[C@@H]1SC[C@@H]2NC(=O)N[C@@H]21]

A “biotinylated species” (e.g., a biotinylated affinity agent) refers to a complex formed by covalently bonding a molecule of biotin to a second species (e.g., an affinity agent). “Free biotin”, as used herein, refers to a molecule of biotin which is not covalently attached to a second species (e.g., an affinity agent). Both biotin and biotinylated species may be conjugated (e.g., through a non-covalent interaction, e.g., a hydrogen bond) to another species (e.g., streptavidin).

As used herein, the term “biotinylated affinity agent” refers to a biotinylated molecule that can specifically bind to a target antigen or complementary nucleic acid sequence. The biotinylated affinity agent may be a biotinylated antibody or antigen-binding fragment thereof or a biotinylated oligonucleotide. The preparation of biotinylated molecules is a process well known and understood in the art. In some embodiments, the molecule is biotinylated with a biotin derivative, including but not limited to iminobiotin, desthiobiotin, disulfide biotin azide, disulfide biotin alkyne or other biotin derivatives.

As used herein, the term “biotin endcapped crosslinked streptavidin-conjugated particles,” “biotin endcapped crosslinked streptavidin-conjugated monoliths,” or “biotin endcapped crosslinked streptavidin-conjugated membranes” refers to a particle, monolith, or membrane conjugated to one or more crosslinked streptavidin molecules that are each associated with one or more biotinylated affinity agents and a biotin molecule. The crosslinked streptavidin of a biotin endcapped crosslinked streptavidin-conjugated particle may include fewer available binding sites than a crosslinked streptavidin-conjugated particle which is not biotin endcapped.

As used herein, the term “nonporous” or “nonporous core” as used herein, refers to a material or a material region (e.g., the core) that has a pore volume that is less than 0.1 cc/g. Preferably, nonporous polymer cores have a pore volume that is less than 0.10 cc/g (e.g., 0.05 cc/g), and preferably less than 0.02 cc/g, in some embodiments. Pore volume is determined using methods known in the art based on multipoint nitrogen sorption experiments (Micromeritics ASAP 2400; Micromeritics Instruments Inc., Norcross, GA).

As used herein, the term “monolith” refers to a collection of individual particles packed into a bed formation, in which the shape and morphology of the individual particles are maintained. The particles are advantageously packed using a material that binds the particles together. Examples of suitable monoliths and binding materials are known in the art and further described in US Publication No. US 2023/0294073, incorporated herein by reference.

As used herein, the term “membrane” refers to a selective barrier, such as a semi-permeable barrier. A membrane may be a filtration membrane.

As used herein, the term “polyclonal antibody” refers to an antibody or a population of antibodies that has specificity to one or more antigens (such as, e.g., host cell proteins from a host cell line). A population of polyclonal antibodies recognize one or more distinct epitopes of the one or more antigens.

As used herein, the term “conjugate” refers to a compound formed by the chemical bonding of a reactive functional group of one molecule or macromolecule, such as streptavidin, with an appropriately reactive functional group of another molecule, such as an epoxide. An example of suitably reactive functional groups is a nucleophile/electrophile pair. For instance, the nucleophile may be an amine group from an amino acid of streptavidin, and the electrophile is an epoxide.

As used herein, the term “conjugated” refers to the linkage of two molecules formed by the chemical bonding of a reactive functional group of one molecule, such as streptavidin, with an appropriately reactive functional group of another molecule, such as an epoxide.

As used herein, the term “streptavidin leachate” refers to the dissociation of one or more streptavidin tetramers into streptavidin monomers, such that the monomers are not conjugated to a solid support, such as a nonporous particle described herein. Streptavidin leachate may be detected using known detection methods, including UV absorbance.

### Crosslinked Streptavidin Materials

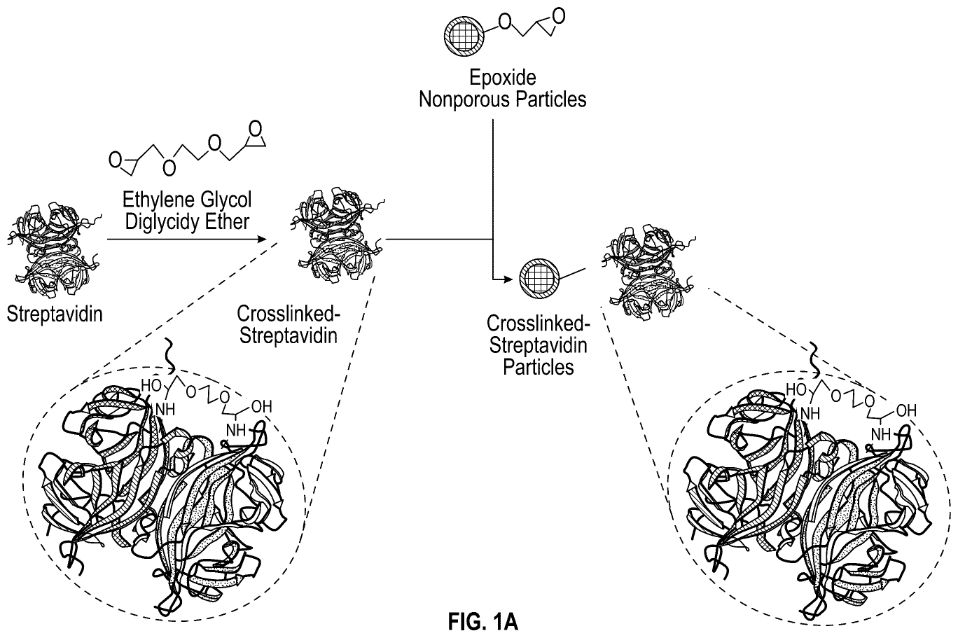

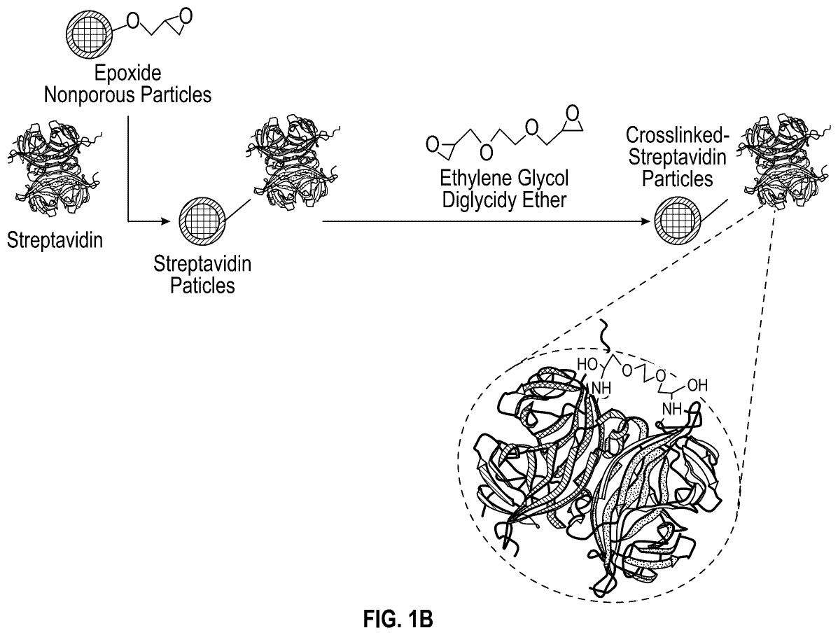

Provided herein are crosslinked streptavidin-conjugated chromatographic materials, and methods of producing said materials. Streptavidin-conjugated materials can be prepared by a variety of methods. In some embodiments, the method first utilizes a crosslinker to generate a plurality of crosslinked streptavidin molecules. The crosslinked streptavidin molecules may then be conjugated to the surface of a chromatographic material, such as a plurality of nonporous particles (e.g., prepared as described in Example 1). FIG. 1A graphically depicts said method wherein crosslinked streptavidin molecules are immobilized onto a plurality of nonporous particles. Alternatively, crosslinking of the streptavidin can occur after a plurality of streptavidin molecules (not crosslinked) are conjugated to the surface of a plurality of nonporous particles. FIG. 1B graphically depicts said method. Example 2 describes a method of preparing the crosslinked streptavidin-conjugated particles according to the method as shown in FIG. 1A. Example 3 describes a method of preparing the crosslinked streptavidin-conjugated particles according to the method as shown in FIG. 1B.

### Crosslinking Moieties

In both methods, a crosslinker is used to crosslink monomers or dimers of streptavidin. The selection of crosslinker length is important for achieving primarily intramolecular crosslinking within a tetramer of streptavidin (e.g., crosslinking two monomers of a streptavidin tetramer or crosslinking two dimers of a streptavidin tetramer). That is, the crosslinker must have a length sufficient to generate said intramolecular linkages without generating intermolecular linkages across tetramers, which can impact the binding of biotinylated affinity agents to the streptavidin binding sites.

A number of crosslinkers are suitable for use in the methods described herein, provided that said crosslinkers are a length that can achieve intramolecular crosslinking with minimal intermolecular crosslinking as described above. The bifunctional crosslinkers used herein may be a homo-functional crosslinker, i.e., the reactive groups are the same, or a hetero-functional crosslinker, i.e., the reactive groups are different. In some embodiments, the homo-functional crosslinkers contain amine-to-amine reactive groups or sulfhydryl-to-sulfhydryl reactive groups. In some embodiments, the hetero-functional crosslinkers contain amine-to-sulfhydryl reactive groups or carboxyl-to-amine reactive groups.

As would be understood by one of ordinary skill in the art, amine reactive groups of a crosslinker form a stable bond with primary amines, such as those found on lysine side chains or N-terminal amines. Sulfhydryl reactive groups of a crosslinker form stable bonds with exposed cysteine residues. Carboxyl reactive groups of a crosslinker form stable bonds with carboxyl-terminal ends of a protein or on aspartate or glutamate side chains. Accordingly, an amine-to-amine reactive crosslinker may be used to generate a linkage between two amine groups present in a streptavidin tetramer. Similarly, a sulfhydryl-to-sulfhydryl reactive crosslinker may be used to generate a linkage between two sulfhydryl groups present in a streptavidin tetramer. An amine-to-sulfhydryl reactive crosslinker may be used to generate a linkage between an amine group and a sulfhydryl group present in a streptavidin tetramer. A carboxyl-to-amine reactive crosslinker may be used to generate a linkage between a carboxyl group and an amine group present in a streptavidin tetramer.

The length of a crosslinker may be measured by the length of the spacer between the two reactive groups. In some embodiments, the crosslinker has a length that is from about 1 Å and 30 Å. That is, in some embodiments, the crosslinker may be a homo-functional crosslinker with a spacer arm length of from about 1 Å to about 30 Å. In some embodiments, the crosslinker may be a hetero-functional crosslinker with a spacer arm length of from about 1 Å to about 30 Å.

For example, but not by way of limitation, the crosslinker may be selected from the group including: succinimydyl 3-(2-pyridyldithio)propionate, tris-(succinimidyl)aminotriacetate, tris(2-maleimidoethyl)amine, p-malemidiophenylisocyanate, N-hydroxysuccinimide, succinimidyl 4-(p-maleimidophenyl)butyrate, succinimidyl 6-((beta-maleimidopropionamideo)hexanoate), succinimidyl 4-(N-maleimidomethyl)cyclohexane-1-carboxy-(6-amidocaproate), succinimidyl iodoacetate, succinimidyl 3-(bromoacetamido)propionate, 1,11-bismaleimido-triethyleneglycol, 1,8-bismaleimido-diethyleneglycol, dithiobismaleimidoethane, 1,4-bismaleimidobutane, bismaleimidohexane, succinimidyl (4-iodoacetyl)aminobenzoate, sulfosuccinimidyl (4-iodoacetyl)aminobenzoate, N-gamma-maleimidobutyryl-oxysulfosuccinimide ester, bismaleimidoethane, sulfosuccinimidyl 4-(N-maleimidophenyl) butyrate, m-maleimidobenzoyl-N-hydroxysulfosuccinimide ester, m-maleimidobenzoyl-N-hydroxysuccinimide ester, N-gamma-maleimidobutyrl-oxysuccinimide ester, N-epsilon-malemidocaproyl-oxysuccinimide ester, N-epsilon-maleimidocaproyl-oxysulfosuccinimide ester, N-beta-maleimidopropyl-oxysuccinimide ester, N-alpha-maleimidoacetoxysuccinimide ester, 1,8-bismaleimido-diethyleneglycol, dithiobismaleimidoethane, 1,4-bismaleimidobutane, bismaleimidohexane, succinimidyl (4-iodoacetyl)aminobenzoate, sulfosuccinimidyl (4-iodoacetyl)aminobenzoate, N-gamma-maleimidobutyryl-oxysulfosuccinimide ester, bismaleimidoethane, sulfosuccinimidyl 4-(N-maleimidophenyl) butyrate, m-maleimidobenzoyl-N-hydroxysulfosuccinimide ester, m-maleimidobenzoyl-N-hydroxysuccinimide ester, N-gamma-maleimidobutyryl oxysuccinimide ester, N-epsilon-maleimidocaproyl-oxysuccinimide ester, N-epsilon-maleimidocaproyl-oxysulfosuccinimide ester, 4-(4-N-maleimidophenyl) butyric acid hydrazide, 3-(2-pyridyldithio) propionyl hydrazide, N-beta-maleimidopropyl-oxysuccinimide ester, N-beta, maleimidopropionic acid hydrazide, N-alpha-maleimidoacet-oxysuccinimide ester, N-kappa-maleimidoundecanoic acid hydrazide, N-epsilon-maleimidocaproic acid hydrazide, succinimidyl 3-(2-pyridyldithio) propionate, succinimidyl 6-(3 (2-pyridyldithio) propionamido) hexanoate, 6-(3′-(2-pyridyldithio) propionamido) hexanoate, sulfosuccinimidyl bis(sulfosuccinimidyl) glutarate-do, bis(sulfosuccinimidyl) 2,2,7,7-suberate-d4, bis(sulfosuccinimidyl) suberate-d0, 3,3′-dithiobis(sulfosuccinimidyl propionate), ethylene glycol bis(sulfosuccinimidylsuccinate), ethylene glycol bis(succinimidyl succinate), 4-succinimidyloxycarbonyl-alpha-methyl-alpha (2-pyridyldithio) toluene, N-kappa-maleimidoundecanoyl-oxysulfosuccinimide ester, dimethyl subermidate, disuccinimidyl tartrate, tert-butyl disuccinimidyl phenyl phosphonate, disuccinimidyl phenyl phosphonic acid, sulfosucciniidyl 6-(4′-azido-2′-nitrophenylamino) hexanoate, disuccinimidyl glutarate, 1-ethyl-3-(3-dimethylaminopropyl) carbodiimide hydrochloride, 1-ethyl-3-(3-dimethylaminopropyl) carbodiimide hydrochloride, N-hydroxysulfosuccinimide, and ethylene glycol diglycidyl ether.

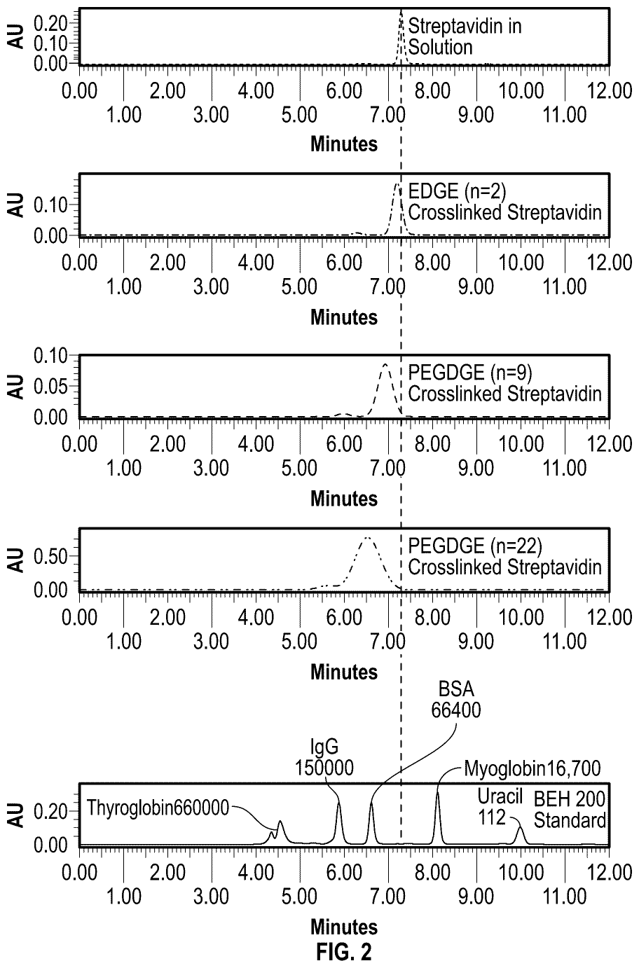

In some embodiments, the crosslinker is a poly(ethylene glycol) diglycidyl ether polymer including m ethylene oxide units. In some embodiments, m is from 1 to 50 ethylene oxide units (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 ethylene glycol units). In some embodiments, a poly(ethylene glycol) diglycidyl polymer may be referred to by the average number of ethylene oxide units. For example, a poly(ethylene glycol) diglycidyl polymer composition with an average of 9 ethylene oxide units may be referred to as m=9 poly(ethylene glycol) diglycidyl. The size exclusion chromatography profiles of exemplary crosslinking moieties are provided in FIG. 2.

Like non-crosslinked streptavidin, crosslinked streptavidin includes a plurality of sites accessible for binding to biotin or a biotinylated species. A site in streptavidin is considered to be accessible for binding if free biotin or a biotinylated species (e.g., a biotinylated affinity agent) is capable of associating with the site (e.g., through a hydrogen bond). Crosslinked streptavidin molecules, as described herein, have the same or similar numbers of accessible binding sites as non-crosslinked streptavidin. In some embodiments, crosslinked streptavidin molecules display at least 50% of the number of accessible binding sites of non-crosslinked streptavidin (e.g., at least 60%, at least 70%, at least 80%, at least 90%, at least 95%, at least 99%, etc.).

Crosslinked streptavidin molecules may be conjugated to the surface of any chromatographic material, such as a particle, monolith, or membrane. Crosslinking of streptavidin may decrease leachate of streptavidin monomers from the particle, monolith, or membrane. In some embodiments, a column including crosslinked streptavidin conjugated to a particle, monolith, or membrane may decrease the leachate of streptavidin monomers from the particle, monolith, or membrane by at least 50% compared to a column including non-crosslinked streptavidin (e.g., at least 60%, at least 70%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, etc.) In some embodiments, a column including crosslinked streptavidin conjugated to a particle, monolith, or membrane may display no leachate of streptavidin monomers.

### Particles

Crosslinked streptavidin molecules of the present disclosure may be conjugated to the surface of a particle. Particles of the present disclosure include a core material (e.g., a polymer core material) and a surface material (e.g., a hydrophilic surface material). In some embodiments, particles may further include a linker configured to bind at one end to the surface material and crosslinked streptavidin at the other.

In some embodiments, the particle may be of any size, for example from about 1 μm to about 50 μm (e.g., from about 1 μm to about 45 μm, from about 1 μm to about 40 μm, from about 1 μm to about 35 μm, from about 1 μm to about 30 μm, from about 1 μm to about 25 μm, from about 1 μm to about 20 μm, from about 1 μm to about 15 μm, from about 1 μm to about 14 μm, from about 1 μm to about 13 μm, from about 1 μm to about 12 μm, from about 1 μm to about 11 μm, from about 1 μm to about 10 μm, etc.). In some embodiments, the average particle in a plurality of particles may be a size of from about 1 μm to about 50 μm (e.g., from about 1 μm to about 45 μm, from about 1 μm to about 40 μm, from about 1 μm to about 35 μm, from about 1 μm to about 30 μm, from about 1 μm to about 25 μm, from about 1 μm to about 20 μm, from about 1 μm to about 15 μm, from about 1 μm to about 14 μm, from about 1 μm to about 13 μm, from about 1 μm to about 12 μm, from about 1 μm to about 11 μm, from about 1 μm to about 10 μm, etc.). In some embodiments, the average particle in a plurality of particles may be a size of from about 1 μm to about 10 μm.

In some embodiments, a hydrophilic surface or layer may be formed on the outer surface of the particle core. An exemplary method of forming a hydrophilic surface on a particle is as follows. A hydrophilic primer coating solution containing 36.2 g of glycidyl methacrylate (GMA), 7.44 g of ethylene glycol dimethacrylate (EDMA), 8.21 g of polyvinylpyrrolidone (PVP360, average molecular weight 360,000) and 489.4 g of reagent alcohol (90% ethanol, ~5% methanol and ~5% isopropanol). This solution is added into to a mixture containing the nonporous polymer cores at a constant flow rate over about 1.5 hours to form a hydrophilic surface.

In some embodiments, a linker may be bound to the surface of the particle (e.g., the hydrophilic surface of the particle). In some embodiments, the linker is a bifunctional molecule with a first moiety on a first end and a second moiety on a second end. The first moiety is configured to bind to the hydrophilic surface of particle and the second moiety is configured to bind to streptavidin. In some embodiments, the reaction binding the linker to the surface of the particle is the ring opening of an epoxide. Alternative reactions bonding the linker and the particle surface include amide bond formation, cyanogen bromide reaction, or an aldehyde condensation

In some embodiments, the crosslinked streptavidin molecules may be conjugated to a hydrophilic surface with an epoxy linker, for example, an epoxy linker of Formula I:

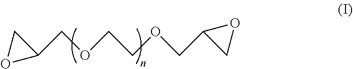

wherein n is between 1-12. In some embodiments, n is 1, 4, or 9. In some embodiments, n is 1.

In some embodiments, the chromatographic material includes porous particles. Porous particles may have a pore volume of at least 0.1 cc/g (e.g., at least 0.2 cc/g, at least 0.3 cc/g, at least 0.4 cc/g, at least 0.5 cc/g, at least 0.6 cc/g, at least 0.7 cc/g, at least 0.7 cc/g, at least 0.8 cc/g, at least 0.9 cc/g, at least 1.0 cc/g, at least 1.1 cc/g, at least 1.2 cc/g, at least 1.3 cc/g, at least 1.4 cc/g, at least 1.5 cc/g, at least 1.6 cc/g, at least 1.7 cc/g, at least 1.8 cc/g, at least 1.9 cc/g, at least 2.0 cc/g, etc.). In some embodiments, porous particles may have a pore volume of at least 1.3 cc/g. The porous particles may include a polymer core, a silica core, or a hybrid organic/inorganic core. In some embodiments, the porous particles have an average diameter of between 1-10 μm.

In any of the above embodiments, the coverage of the crosslinked streptavidin molecules on the surface of particle may be from about 0.1 μg/mg of particle to about 50 μg/mg of particle to about 50 μg/mg of particle (e.g., from about 0.2 μg/mg of particle to about 45 μg/mg of particle, from about 0.3 μg/mg of particle to about 40 μg/mg of particle, from about 0.4 μg/mg of particle to about 35 μg/mg of particle, from about 0.5 μg/mg of particle to about 30 μg/mg of particle, from about 0.6 μg/mg of particle to about 25 μg/mg of particle, from about 0.7 μg/mg of particle to about 20 μg/mg of particle, from about 0.8 μg/mg of particle to about 15 μg/mg of particle, from about 0.9 μg/mg of particle to about 10 μg/mg of particle, from about 1 μg/mg of particle to about 8 μg/mg of particle, from about 2 μg/mg of particle to about 6 μg/mg of particle, etc.).

### Monoliths and Membranes

It will be understood by those of skill in the art that the methods and materials described above are also applicable to other chromatographic materials, such as monoliths or membranes. In some embodiments, the chromatographic material includes a monolith. In said embodiments, the crosslinked streptavidin molecules may be conjugated to a surface present in the monolith. In some embodiments, the chromatographic material includes a membrane. In said embodiments, the crosslinked streptavidin molecules may be conjugated to a surface of the membrane.

As described above, crosslinking of the streptavidin molecules may be performed prior to conjugation to the particle, monolith, or membrane or after conjugation to the particle, monolith, or membrane. Streptavidin molecules or crosslinked streptavidin molecules may be conjugated to the surface of the particle, monolith, or membrane using methods known in the art. For example, but not by way of limitation, the crosslinked streptavidin molecules or streptavidin molecules may be conjugated to the particle, monolith, or membrane using an epoxide reaction.

In some preferred embodiments, the crosslinked streptavidin molecules are conjugated to the hydrophilic surface of a nonporous polymer particle. Said nonporous polymer particles and the synthesis thereof are further described in PCT Publication No. WO 2024/224364, incorporated herein by reference. Example 1 further describes methods of preparing nonporous polymer particles that may be used in conjunction with the present technology. The resultant particles, monoliths, or membranes including crosslinked streptavidin molecules provide a plurality of accessible streptavidin binding sites.

### Biotin Endcapped Crosslinked Streptavidin Materials

A biotin endcapped crosslinked streptavidin material is any crosslinked streptavidin material (e.g., a crosslinked streptavidin-conjugated particle, a crosslinked streptavidin-conjugated monolith, or a crosslinked streptavidin-conjugated membrane) wherein accessible binding sites in the crosslinked streptavidin which are not bound to a biotinylated affinity agent are bound to free biotin. In some embodiments, the biotinylated affinity agent free biotin are bound to the streptavidin in a 1:1 molar ratio, a 1:3 molar ratio, a 1:5 molar ratio, a 1:8 molar ratio, a 1:10 molar ratio, a 1:15 molar ratio, a 1:20 molar ratio, a 1:25 molar ratio, a 1:30 molar ratio, a 1:35 molar ratio, a 1:40 molar ratio, a 1:45 molar ratio, or a 1:50 molar ratio.

Biotin and the biotinylated affinity agent may be bound to streptavidin through a variety of methods. For example, but not by way of limitation, crosslinked streptavidin-conjugated materials may be biotin endcapped by first treating the material with a solution including the biotinylated affinity agent until the material is saturated with the biotinylated affinity agent. Then, the material may be treated with a solution including free biotin, thereby allowing free biotin to associate with accessible streptavidin binding sites unoccupied by the biotinylated affinity agent. A non-limiting example of such a procedure is described in Example 5.

Alternatively, crosslinked streptavidin-conjugated materials may be biotin endcapped by treating the material with a solution including the biotinylated affinity agent and free biotin. The biotinylated affinity agent and free biotin may be present in the solution in a 1:1 molar ratio, a 1:3 molar ratio, a 1:5 molar ratio, a 1:8 molar ratio, a 1:10 molar ratio, a 1:15 molar ratio, a 1:20 molar ratio, a 1:25 molar ratio, a 1:30 molar ratio, a 1:35 molar ratio, a 1:40 molar ratio, a 1:45 molar ratio, or a 1:50 molar ratio. A non-limiting example of such a procedure is described in Example 6.

### Biotinylated Affinity Agents

A biotinylated affinity agent includes a biotin moiety bound to a molecule or macromolecule configured to bind a specific substrate (e.g., an antigen or antibody). The biotin moiety allows the biotinylated affinity agent to interact with the surface of the crosslinked streptavidin-conjugated particle, associating the biotinylated affinity agent to the particle. A crosslinked streptavidin-conjugated particle associated with a biotinylated affinity agent (and/or biotin) may be characterized by reduced degradation of crosslinked streptavidin relative to a crosslinked streptavidin-conjugated particle not associated with a biotinylated affinity agent (and/or biotin) (e.g., by reducing dissociation of a monomer from the streptavidin tetramer). A crosslinked streptavidin-conjugated particle associated with a biotinylated affinity agent (and/or biotin) may be characterized by reduced streptavidin leachate relative to a crosslinked streptavidin-conjugated particle not associated with a biotinylated affinity agent (and/or biotin).

A biotinylated affinity agent may be a biotinylated antibody, or a biotinylated antigen-binding fragment thereof. In some embodiments, the biotinylated affinity agent is a biotinylated oligonucleotide.

In some embodiments, the biotin moiety of the biotinylated affinity agent may be a biotin derivative. Exemplary biotin derivatives include iminobiotin, desthiobiotin, disulfide biotin azide, disulfide biotin alkyne or other biotin derivatives. Affinity agents may be biotinylated by any means known in the art.

### Biotinylation of Crosslinked Streptavidin

Due to the size of the biotinylated affinity agent, one or more crosslinked streptavidin binding sites on the crosslinked streptavidin-conjugated particle may not be conjugated to the affinity agent. This reduces the stability of the crosslinked streptavidin, which may result in an increased streptavidin leachate. The particles described herein stabilize crosslinked streptavidin by binding free biotin to open crosslinked streptavidin binding sites.

In some embodiments, the ratio of biotinylated affinity agent bound to crosslinked streptavidin binding sites to free biotin bound to crosslinked streptavidin binding sites is about 1:1, 1:3, 1:5, 1:8, 1:10, 1:15, 1:20, 1:25, 1:30, 1:35, 1:40, 1:45, or 1:50. In some embodiments, at least 1% of accessible binding sites of the crosslinked streptavidin molecules are bound with the biotinylated affinity agent or free biotin (e.g., at least 2%, at least 3%, at least 4%, at least 5%, at least 6%, at least 7%, at least 8%, at least 9%, at least 10%, at least 11%, at least 12%, at least 13%, at least 14%, at least 15%, at least 20% at least 30%, at least 40%, at least 50%, at least 60%, at least 70%, at least 80%, at least 85%, at least 90%, at least 95%, at least 99%, etc.).

### Methods of Forming Particles

An exemplary method for forming a particle is as follows. First, 561.1 g of reagent alcohol (90% ethanol, ~5% methanol and ~5% isopropanol), 16.9 g of polyvinylpyrrolidone (PVP-40, average molecular weight 40,000), 1.6 g of 2,2′-Azobis(2-methylpropionitrile) (AIBN), 6.7 g of Triton™ N-57, 80.1 g of styrene and 2.4 g of poly(propylene glycol) dimethacrylate (average molecular weight 560) were charged into a reactor. After purging with nitrogen, the reaction mixture was heated to 70° C. with stirring and was held at 70° C. until the completion of all the reaction steps. Then, the reaction mixture was held at 70° C. for 3 hours, a solution containing 52.0 g of divinylbenzene (80% by weight), 24.0 g of styrene, 51.0 g of PVP-40, 1080.4 g of reagent alcohol (90% ethanol, ~5% methanol and ~5% isopropanol) and 54.1 g of p-xylene was added to the reaction mixture at a constant flow rate over two hours. Finally, after the completion of solution charge in step two, a primer coating solution containing 31.2 g of glycidyl methacrylate (GMA), 6.2 g of ethylene glycol dimethacrylate (EDMA), 12.9 g of PVP-40 and 381.9 g of reagent alcohol (90% ethanol, ~5% methanol and ~5% isopropanol) was added to the reaction mixture at a constant flow rate over 1.5 hours. After the reaction mixture was held at 70° C. for a total of 20 hours, the particles were separated from the reaction slurry by filtration. The particles were then washed with methanol, followed by tetrahydrofuran (THF), and followed by acetone. The final product was dried in vacuum oven at 45° C. overnight. 91.8 g of monodisperse 2.3 μm polymer particles were obtained.

An exemplary method for forming particles including a hydrophilic surface is described in Example 1. Other methods for forming particles are known in the art (see, e.g., U.S. Patent Publication Nos 2019/0322783 and 2024/0362428, the methods of forming particles of which are incorporated by reference herein).

### Methods of Forming Crosslinked Streptavidin-Conjugated Particles

In some embodiments, streptavidin is crosslinked while the streptavidin is unassociated with a particle, e.g., by interacting the streptavidin with a crosslinking moiety. Then, the formed crosslinked streptavidin may be interacted with a particle (e.g., a particle with a hydrophilic surface and/or a linker on attached to the hydrophilic surface). For example, in embodiments wherein the particle has an epoxide linker on the surface of the particle, crosslinked streptavidin may react with the epoxide linker via the ring opening of a surface epoxide. An exemplary method for associating crosslinked streptavidin to a particle is described in Example 2.

In some embodiments, streptavidin is crosslinked while the streptavidin is associated with a particle. First, a particle (e.g., a particle with a hydrophilic surface and/or a linker on attached to the hydrophilic surface) is formed. Then, the particle is interacted with non-crosslinked streptavidin. For example, in embodiments wherein the particle has an epoxide linker on the surface of the particle, non-crosslinked streptavidin may react with the epoxide linker via the ring opening of a surface epoxide. Once conjugated to the surface, the streptavidin may be crosslinked, e.g., by the addition of a crosslinking moiety. An exemplary method for crosslinking streptavidin associated to a particle is described in Example 3.

### Methods of Forming Biotin Endcapped Streptavidin-Conjugated Particles

Crosslinked streptavidin-conjugated particles may be biotin endcapped by first packing a column (e.g., an affinity chromatography column) with the crosslinked streptavidin-conjugated particles. The column may then be associated with a liquid chromatography system. Exemplary columns and liquid chromatography systems are known in the art. Further non-limiting examples of columns and liquid chromatography systems are described herein.

The liquid chromatography system is configured to flow a solution over the packed column of crosslinked streptavidin-conjugated particles. In some embodiments, a solution including the biotinylated affinity agent is flown over the packed column. Then, once saturation of the biotinylated affinity agent has been reached, a second solution including free biotin is flown over the column. Alternatively, a solution including both a biotinylated affinity agent and free biotin is flown over the column until saturation is reached.

An advantage of the method of pumping the solution including the biotinylated affinity agent and biotin across a bed of particles packed into a device includes precise metering of reagents, contact times and ability to use post column detectors (e.g., use of detector to monitor amount of biotinylated molecule eluting from column versus loading on the column).

After flowing the solution through the plurality of particles packed in the column, the chromatographic device can be washed with water, PBS buffer or storage buffer, and then stoppered or enclosed to prevent evaporation and, if desired, stored in a refrigerator until ready for use.

In some embodiments, a column packed with a plurality of crosslinked streptavidin particles can be washed with water, a buffer or storage solution, and/or an acetonitrile-based solution (e.g., 20% acetonitrile and 1% phosphoric acid) prior to adding the solution containing biotinylated affinity agent. The column packed with the plurality of functionalized streptavidin particles can be stored prior to the loading of the biotinylated affinity agent.

### Columns and Liquid Chromatography Systems

The biotin endcapped crosslinked streptavidin-conjugated particles, monoliths, or membranes described herein may be used to prepare an affinity chromatographic column, an affinity monolith, or an affinity membrane, respectively. Additionally, crosslinked streptavidin-conjugated particles, monoliths, or membranes may be prepared in an affinity chromatographic column or a liquid chromatography system which is used to endcap the crosslinked streptavidin-conjugated particles, monoliths, or membranes.

A number of column sizes and materials are suitable for use. In some embodiments, the column material is stainless steel, polyetheretherketone (PEEK) lined steel, titanium, or a stainless steel alloy such as MP35n. In some embodiments, the column material is plastic. In some embodiments, the column has an internal diameter ranging from 75 μm to 4.6 mm. In some embodiments, the column has a length between 5 to 300 mm. The column surface can be unmodified or modified to generate a high-performance surface. Chromatography columns suitable for use with the methods disclosed herein are compatible with any standard liquid chromatography system, including high-performance liquid chromatography (HPLC) systems, ultra-high performance liquid chromatography (UHPLC) systems, and fast protein liquid chromatography (FPLC) systems.

In some embodiments, the liquid chromatography system is connected in series to a detector. Detectors suitable for use in the methods disclosed herein include detectors for ultraviolet spectroscopy, fluorescence spectroscopy, and/or mass spectrometry. In some embodiments, the liquid chromatography system is connected in series to a detector for ultraviolet spectroscopy. In some embodiments, the liquid chromatography system is connected in series to a detector for fluorescence spectroscopy. In some embodiments, the liquid chromatography system is connected in series to detector for mass spectrometry. In some embodiments, the liquid chromatography system is connected to one or more of the detectors in series.

In some embodiments, the interior surfaces of the column are treated to reduce non-specific binding and enhance overall efficiency of the liquid chromatography system. In particular, an alkylsilyl coating or other high-performance surface is provided to limit or reduce non-specific binding of a sample with walls or interior surfaces of a column body. Without wishing to be bound by theory, it is believed that an alkylsilyl coating covering metal surfaces prevent or minimize contact between fluids passing through the column body and the interior surfaces of the column. Typically, the alkylsilyl coating is applied to metal surfaces defining what is known as a wetted path of the column. A metal wetted path includes all surfaces formed from metal that are exposed to fluids during operation of the chromatographic column. The metal wetted path includes not only column body walls, but also metal frits disposed within the column.

In general, the alkylsilyl coating is applied through a vapor deposition technique. Precursors are charged into a reactor in which the part to be coated is located. Vaporized precursors react on the surfaces of the part to be coated to form a first layer of deposited material. The vapor deposition can be applied in a stepwise function to apply a number of layers of deposited material to the surfaces to grow a thickness of the coating and/or to apply layers of different materials (e.g., alternating between a first and second material) to form the coating.

In some embodiments, the alkylsilyl coating is applied to other portions of the liquid chromatography system. For example, the alkylsilyl coating can be applied to metal components residing upstream and downstream of the column. Specifically, the alkylsilyl coating can be applied to an injector of the liquid chromatography system and to post column tubing and connectors.

In one embodiment, the alkylsilyl coating includes a hydrophilic, non-ionic layer of polyethylene glycol silane. In another embodiment, the alkylsilyl coating is formed from one or more of the following precursor materials bis(trichlorosilyl)ethane or bis(trimethoxysilyl)ethane. Other embodiments of alkylsilyl coatings suitable for use with the present technology are described in U.S. Patent Publication No. 2019/0086371 and U.S. Application Publication No. 2022/0118443.

### Methods of Determining Streptavidin Leachate

Streptavidin leachate can be monitored by UV absorbance (e.g., using a detector associated with the liquid chromatography system), for example at 280 nm. For example, particles, monoliths, or membranes including biotin endcapped crosslinked streptavidin-conjugated particles may be washed with a mobile phase and the eluent monitored by UV at 280 nm. As the biotin endcapped crosslinked streptavidin of the particles, monoliths, or membranes described herein reduce streptavidin leachate, little to no absorbance following washing with the mobile phase will be detected.

Streptavidin leachate can be tested by flowing a mobile phase across the column including a plurality of crosslinked streptavidin-conjugated particles, a crosslinked streptavidin-conjugated monolith, or a biotin endcapped streptavidin-conjugated membrane. Eluent from the column, monolith, or membrane may be monitored by UV absorbance at 280 nm for the presence of streptavidin monomers in the eluent. Eluent may further be detected using a mass spectrometer to detect the presence of streptavidin monomers as determined by molecular weight.

The mobile phase may include a buffer, such as phosphate buffered saline (PBS). The mobile phase may further include an organic solvent such as, but not limited to, acetonitrile, methanol, or isopropanol. The mobile phase may further include an acid, such as phosphoric acid. Additionally or alternatively, the mobile phase may include a detergent. The concentration of the organic solvent, detergent, and/or acid may be adjusted as would be understood by one of ordinary skill in the art.

In some embodiments, the biotin endcapped crosslinked streptavidin-conjugated particles, biotin endcapped crosslinked streptavidin-conjugated monolith, or biotin endcapped crosslinked streptavidin-conjugated membrane results in no detectable streptavidin leachate as determined by mass spectrometry.

Accordingly, the biotin endcapped crosslinked streptavidin-conjugated particles, monoliths, or membranes described herein may result in reduced streptavidin leachate as measured by UV absorbance. In some embodiments, the UV absorbance following washing with a mobile phase is less than 10 mAU.

Alternatively, reduction in streptavidin leachate may be measured as a reduction in peak area following washing with a mobile phase. For said measurement, a comparison is made between a particle, membrane, or monolith having biotin endcapped crosslinked streptavidin versus a particle, membrane, or monolith having crosslinked streptavidin which includes only a biotinylated affinity agent and does not include free biotin. In some embodiments, the 4th peak is used as the measurement for determining reduction in streptavidin leachate. In some embodiments, the biotin endcapped crosslinked streptavidin-conjugated particle, membrane, or monolith results in an 85% reduction in absorbance as measured at the 4th peak. In some embodiments, the crosslinked streptavidin-conjugated particle, membrane, or monolith results in a 90% or 95% reduction in absorbance as measured at the 4th peak.

### EXAMPLES

The following examples are meant to illustrate the invention and are not meant to limit the invention in any way.

### Example 1: Addition of an Epoxy Linker to Hydrophilic Particles

The nonporous, epoxy-modified hydrophilic particles for use in the disclosed methods were prepared as follows. As a first step, 1500 g of reagent alcohol (90% ethanol, ~5% methanol, and ~5% isopropanol), 45.1 g of polyvinylpyrrolidone (PVP-40), 4.8 g of 2,2′-Azobis(2-methylpropionitrile), 5.9 g of surfactant (Triton™ N-57, available from Dow, Inc), and 81.7 g of styrene were charged into a reactor. After the reactor was purged with nitrogen gas, the reaction mixture was heated to and maintained at 70° C. with stirring for 3 hours.

After three hours, a solution containing 110.4 g of divinylbenzene 80 (DVB), 39.7 g of PVP-40, 510 g of reagent alcohol, and 100.2 g of p-xylene was added to the reaction mixture at a constant flow rate over two hours. Following this step, a primer coating solution containing 26.0 g of glycidyl methacrylate (GMA), 26.0 g of ethylene glycol dimethacrylate (EDMA), 36.4 g of PVP-40, and 560 g of reagent alcohol were added to the reaction mixture at a constant flow rate over 1.5 hours.

The reaction mixture was maintained at 70° C. for a total of 20 hours, after which the particles were separated from the reaction slurry by filtration. The particles were then washed sequentially with methanol, tetrahydrofuran (THF), and acetone. The final product was dried in a vacuum oven at 45° C., resulting in monodisperse 3.5 μm polymer particles. These particles contain a gradient polystyrene/DVB core with a poly(GMA/EDMA) primer. While the above reaction conditions generate 3.5 μm polymer particles, it is understood that particles ranging in sizes from 1.5 μm to 8 μm are within the scope of the disclosure. By altering the concentrations of PVP-40, 2′2-Azobis(2-methylpropionitrile), and Triton N-57, one of ordinary skill in the art could generate a range of particle sizes.

The resultant 3.5 μm, polystyrene/DVB particles with the poly(GMA/EDMA) primer were then coated with a hydrophilic layer. 70 g of the particles were hydrolyzed in 0.5M H2SO4 at 60° C. for 1-20 hours. The hydrolyzed particles were washed sequentially with MilliQ water and methanol, and then dried under vacuum at 45° C. overnight. The dried particles were added into a 1 L three-necked round bottom flask with an overhead stirring motor, stirring shaft, and stir blade, a water-cooled condenser, a nitrogen inlet, and a probe-controlled heating mantle. 700 mL of anhydrous diglyme (diethylene glycol dimethyl ether) was added, the flask sealed and purged with nitrogen for 15 minutes with moderate stirring. 2.0 g of potassium tert-butoxide was added, and the reaction was raised to 70° C. To generate the hydrophilic layer, a mixture of 10.5 g glycidol, 2.6 g of glyceroltriglycidyl ether, and 14.9 g of anhydrous diglyme was prepared separately and added to the particle mixture in four equal aliquots in 30-minute intervals. The reaction was held at 70° C. for 20 hours, cooled to RT, and filtered. The resulting particles were washed sequentially with water 6 times, methanol 3 times, and then dried under vacuum overnight at 45° C. The following procedure results in a hydrophilic layer that is 2-4% (by weight) of the entire particle.

20 g of the resultant 3.5 μm particles with the hydrophilic coating were added to a mixture of 100 g of ethylene glycol diglycidyl ether (EGDGE) and 100 g of MeOH at room temperature. 1 mL of 50% sodium hydroxide in water was added and the reaction was stirred continuously for 20 h. The particles were isolated by filtration, washed with 40 mL of MeOH ten times, and partially dried under nitrogen flow. The particles were stored for later use in a methanol wet bed at 4° C. The resultant particles have sufficient epoxide content to enable functionalization of the particle surface.

### Example 2: Preparation of Crosslinked Streptavidin-Conjugated Particles (Method 1)

Crosslinked streptavidin was prepared using an ethylene glycol diglycidyl ether (EGDGE) crosslinker. To a 10 mg/mL streptavidin solution in sodium carbonate-bicarbonate buffer (pH 9.4) was added ethylene glycol diglycidyl ether (340:1 to 1700:1 molar ratio with streptavidin). The solution was heated at 37° C. with gentle mixing for 4-14 hours. Following the incubation, 83 mg of ethanolamine in 311 μL of sodium carbonate-bicarbonate buffer was added and the reaction was stirred at RT for 1 hour. Then, the buffer was exchanged with 100 mM PBS (pH 7.2) by consecutive wash/centrifugation cycles.

The particles as prepared in Example 1 were then conjugated with the crosslinked streptavidin molecules. 2 g of particles were dispersed in 9.5 mL of a 100 mM sodium carbonate-bicarbonate buffer (pH 9.4). To this, 2 mL of a 10 mg/mL solution of crosslinked streptavidin was added. Next, 28.5 mL of sodium carbonate-bicarbonate buffer containing sodium sulfate, a salting out agent, was added dropwise. The reaction was stirred for 20 hours at 37° C.

Following the 20 h reaction, 1.4 g of ethanolamine in 4.9 mL of sodium carbonate-bicarbonate buffer was added and the reaction was stirred at RT for 3 hours. Particles were isolated by filtration and washed. The washing process includes 4 steps. Step 1 is a 3× wash with water (pH 4) adjusted with HCl. Step 2 is a 3× wash with water/acetonitrile (4:1) with 1% phosphoric acid. Step 3 is a 3× wash with water. And Step 4 is a 2× wash with storage buffer (100 mM PBS, pH 7.2, 0.02% sodium azide). The particles were then stored in a sealed container as a slurry in storage buffer (~10 mL buffer/g of particle) at 4° C. Streptavidin coverage of the particles was determined using a standard bicinchoninic acid (BCA) assay. Streptavidin leachate was assessed by monitoring the eluent from the column following 10, 25 μL injections of 20% acetonitrile and 1% phosphoric acid. Table 1 shows the effects of the crosslinker molar ratio and the reaction time on the streptavidin coverage on a given particle, as well as the resultant streptavidin leachate from the column.

TABLE 1
Crosslinked streptavidin particles prepared with crosslinked streptavidin

| | EGDGE/ | | Streptavidin | |
|---|---|---|---|---|
| | Streptavidin | Reaction | Coverage (μg/mg | % Decrease in |
| Example # | Molar Ratio | Time (h) | particle) | 4^{th} Peak Area* |
| 2a | 340 | 4 | 5.7 | 86 |
| 2b | 1700 | 4 | 13.9 | 62 |
| 2c | 340 | 14 | 8.6 | 80 |
| 2d | 1700 | 14 | 13.4 | 54 |

*Compared to particles prepared without streptavidin crosslinking.

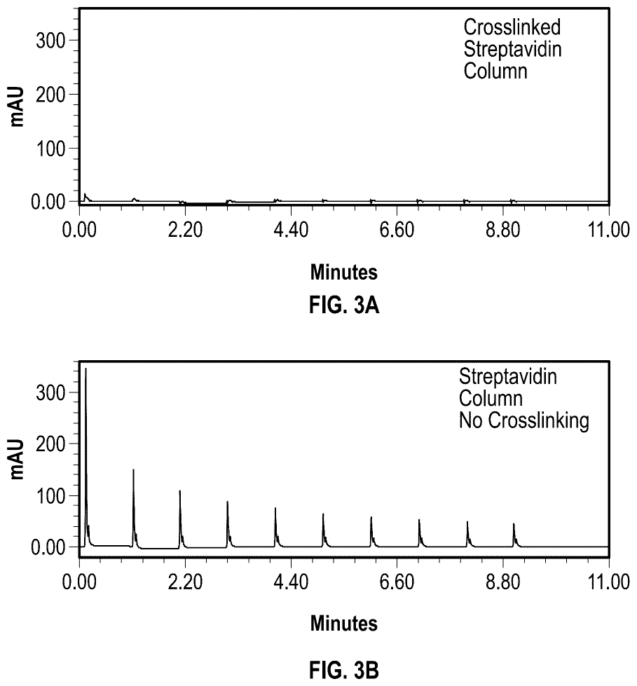

FIG. 3 demonstrates the reduction in leachate observed with crosslinked streptavidin-conjugated particles (top) as compared to streptavidin-conjugated particles (bottom). As measured at the 4th peak, the absorbance for the crosslinked streptavidin-conjugated particles is 3.5 mAU as compared to 91 mAU for the streptavidin-conjugated particles.

The eluent of a column having crosslinked streptavidin-conjugated particles and the eluent of a column having streptavidin-conjugated particles were further analyzed with mass spectrometry for the presence of streptavidin monomers. The respective columns were first washed with 0.1% formic acid (FA) at 0.2 mL/min followed by a 10 μL injection of 50% MeCN with 0.1% (FA). Next, a 3 minute gradient from aqueous 0.1% FA to 80% MeCN in 0.1% FA at a flow rate of 0.2 mL/min was applied. Next, a 15 minute gradient from aqueous 0.1% FA to 80% MeCN in 0.1% FA at a flow rate of 0.2 mL/min was applied. Eluent was monitored with UV followed by mass spectrometry.

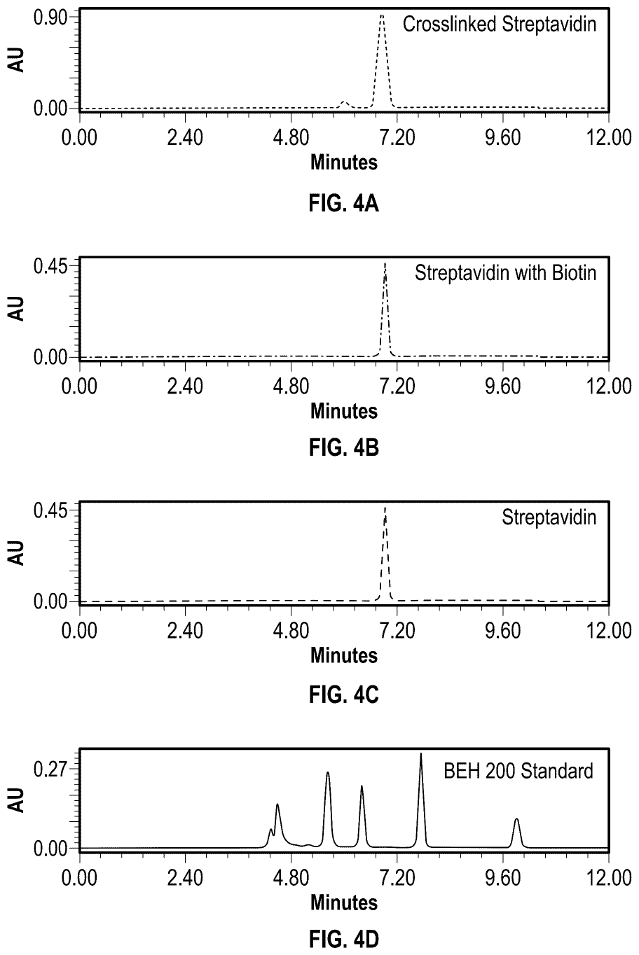

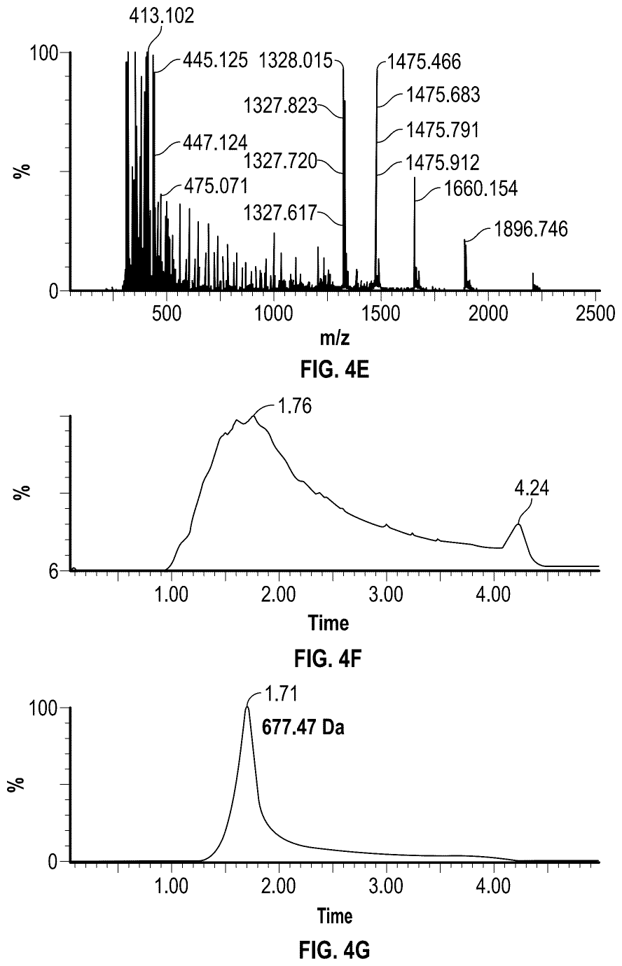

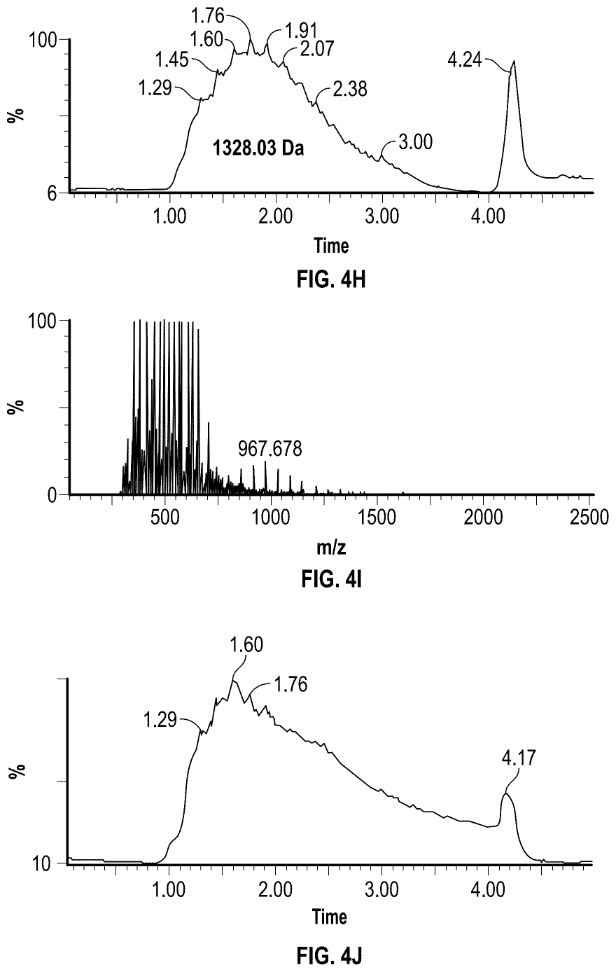

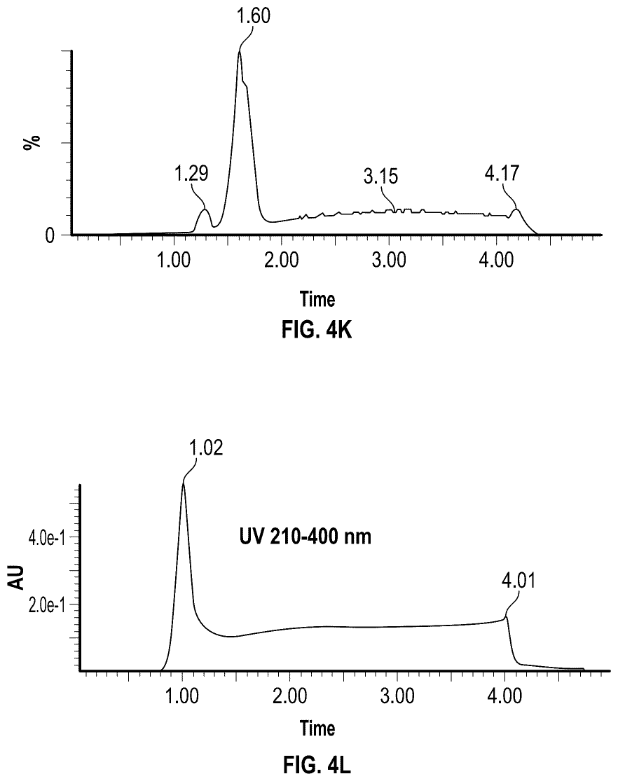

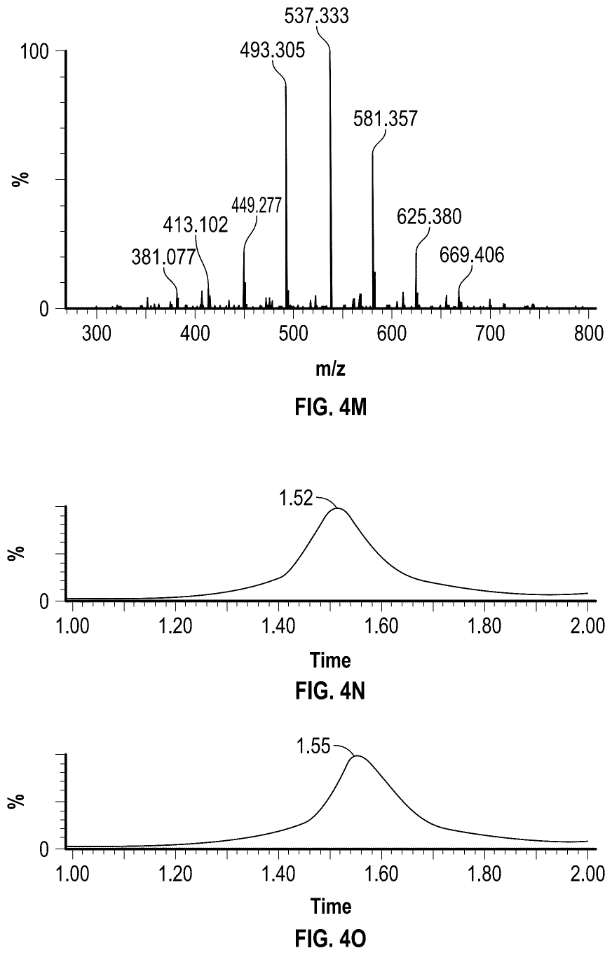

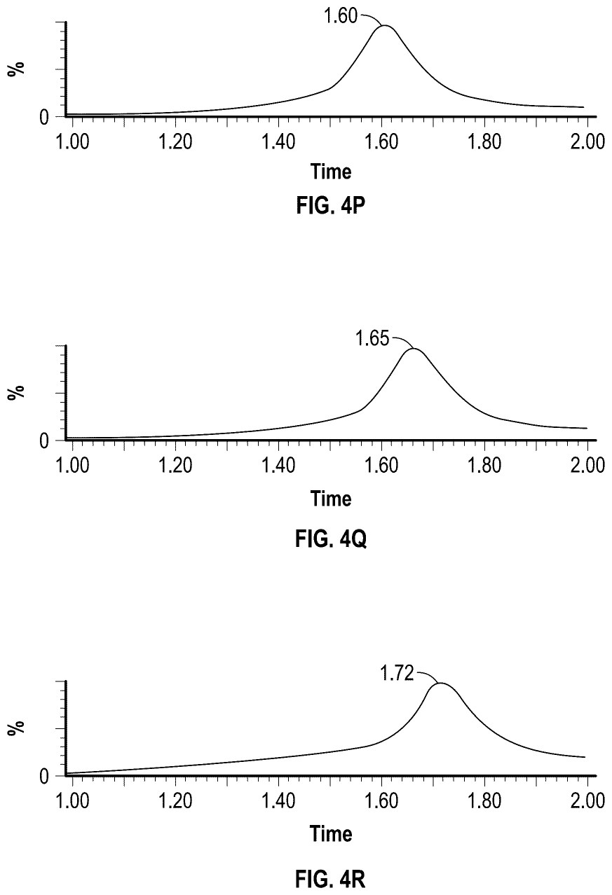

FIGS. 4A-4D demonstrate that the solution of streptavidin molecules treated with a crosslinker had a slightly larger molecular size as compared to streptavidin alone or streptavidin bound with biotin as measured by SEC. FIG. 4E shows the mass spectrometry spectra of the eluent from a column of particles coated with non-crosslinked streptavidin. Signals corresponding to both the hydrophilic particle and the streptavidin monomer are observed. FIGS. 4F-4H track the elution of species of specific masses from the column. FIG. 4I shows the mass spectrometry spectra of the eluent from a column of particles coated with crosslinked streptavidin. Only signals corresponding to the hydrophilic particles were present (i.e. no signals correspond to streptavidin). FIGS. 4J-4L show the TIC MS, BPI MS, and the UV-Vis spectra of the eluent. FIGS. 4M-4R track the elution of species of specific masses from the column. Each tracked mass elutes at a different time.

### Example 3: Preparation of Crosslinked Streptavidin-Conjugated Particles (Method 2)

Particles were functionalized with streptavidin (as received; not crosslinked) followed by crosslinking with an ethylene glycol diglycidyl ether crosslinker. 2 g of particles were dispersed in 9.5 mL of a 100 mM sodium carbonate-bicarbonate buffer (pH 9.4). To this, 2 mL of a 10 mg/mL solution of streptavidin was added. Next, 28.5 mL of sodium carbonate-bicarbonate buffer containing sodium sulfate, a salting out agent, was added dropwise. The reaction was then stirred for 20 hours at 37° C.

Following the 20 h reaction, 1.4 g of ethanolamine in 4.9 mL of sodium carbonate-bicarbonate buffer was added and the reaction was stirred at RT for 3 hours. Particles were then isolated by filtration and washed. The washing process includes 4 steps. Step 1 is a 3× wash with water (pH 4) adjusted with HCl. Step 2 is a 3× wash with water/acetonitrile (4:1) with 1% phosphoric acid. Step 3 is a 3× wash with water. And Step 4 is a 2× wash with storage buffer (100 mM PBS, pH 7.2, 0.02% sodium azide). The particles were then stored in a sealed container as a slurry in storage buffer (~10 mL buffer/g of particle) at 4° C. Streptavidin coverage of the particles was determined using a standard bicinchoninic acid (BCA) assay.

Streptavidin on the particles was then crosslinked with ethylene glycol diglycidyl ether as follows. 1.2 g of the streptavidin-conjugated particles were dispersed in 100 mM sodium carbonate-bicarbonate buffer, pH 9.4 (~10 mL buffer/g of particle). Ethylene glycol diglycidyl ether was added at a final concentration of 30-450 mM. The reaction was then stirred at 37° C. for 4-16 hours. Following the reaction, 0.4 g ethanolamine in 1.5 mL sodium carbonate-bicarbonate buffer was added and the reaction was stirred at RT for 1 hour. Particles were then isolated by filtration and washed sequentially 4 times with water and 2 times with storage buffer (100 mM PBS, pH 7.2, 0.02% sodium azide). The particles were stored in a sealed container as a slurry in storage buffer (~10 mL buffer/g of particle) at 4° C. The effects of the crosslinker concentration and the reaction time on streptavidin leachate from the column is shown in Table 2. Streptavidin leachate was assessed by monitoring the eluent from the column following 10, 25 μL injections of 20% acetonitrile and 1% phosphoric acid.

TABLE 2
Crosslinked streptavidin particles prepared with
crosslinking after streptavidin functionalization.

| | EGDGE | Reaction | Streptavidin | |
|---|---|---|---|---|
| Example | Concentration | Time | Coverage | % Decrease in |
| # | (mM) | (h) | (μg/mg particle) | 4^{th} Peak Area* |
| 3a | 30 | 4 | 6.4 | 38 |
| 3b | 30 | 14 | 6.4 | 41 |
| 30 | 150 | 4 | 6.4 | 50 |
| 3d | 150 | 14 | 6.4 | 44 |
| 3e | 450 | 4 | 6.4 | 53 |

*Compared to the particles prepared without streptavidin crosslinking.

### Example 4: Coupling of Biotin or a Biotinylated Antibody to Crosslinked Streptavidin

The binding efficiency of columns including crosslinked streptavidin-conjugated particles (as synthesized in Example 3) was compared to the binding efficiency of particles conjugated to non-crosslinked streptavidin. Binding to biotin, a biotinylated antibody (anti-insulin), and a biotinylated nanobody were compared. The column of particles in each experiment was prepared by packing the material into a liquid chromatography system.

### Biotin

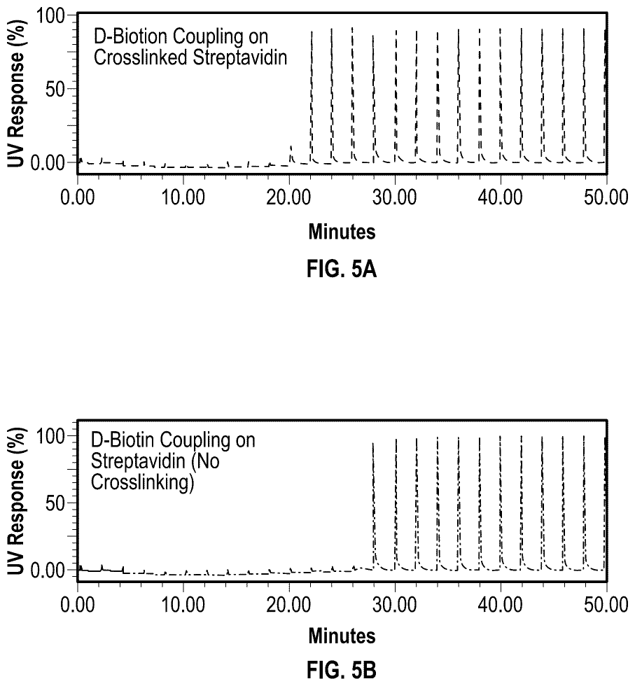

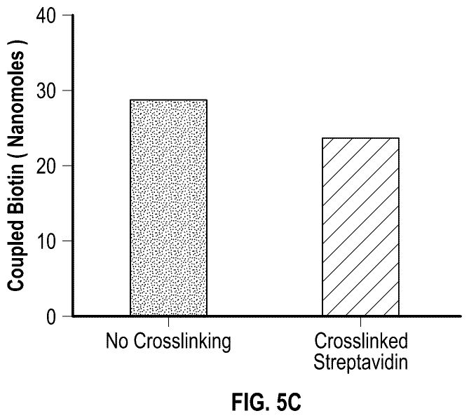

Columns were washed with a mobile phase of 100 mM sodium phosphate (pH 7.4) at a flow rate of 0.15 mL/min. D-biotin, at a concentration of 1 nmol/L, was injected with 1 μL injections until saturation was observed as measured by UV at 210 nm. As shown in FIG. 5A-5B, D-biotin was able to bind to accessible binding sites of streptavidin for both columns. There was an approximate ~17% reduction in biotin binding to crosslinked streptavidin. After accounting for differences in streptavidin coverage of the particles, columns including crosslinked streptavidin particles displayed an approximately 7.3% reduction in biotin binding (FIG. 5C).

### Biotinylated Antibody

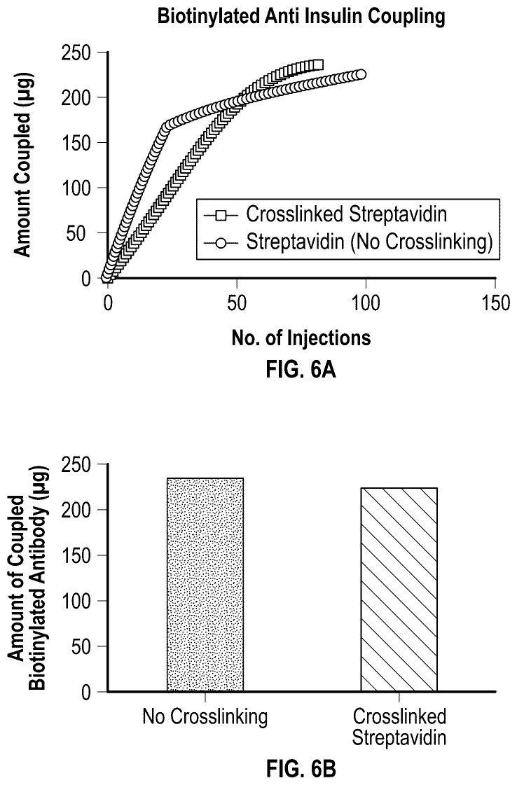

Columns were washed with a mobile phase of 100 mM sodium phosphate (pH 7.4) at a flow rate of 0.1 mL/min. A solution of biotinylated anti-insulin antibody at 1 μg/μL concentration was injected onto the column with 10 μL injections until saturation was observed as measured by UV at 280 nm. As shown in FIG. 6A, the biotinylated antibody was able to bind to accessible binding sites of streptavidin for both columns. There was an approximate 4% reduction in anti-insulin antibody binding after accounting for differences in streptavidin coverage between the particles (FIG. 6B).

### Biotinylated Nanobody

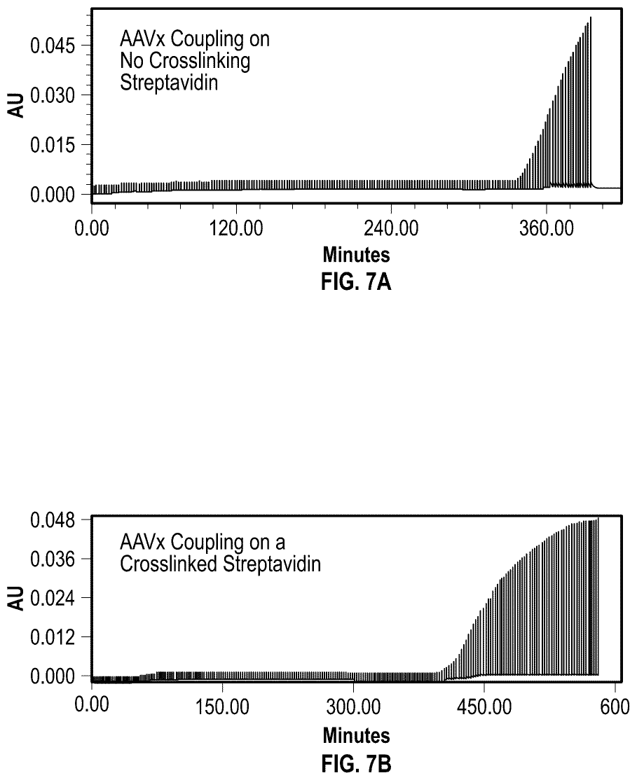

Columns were washed with a mobile phase of 100 mM sodium phosphate (pH 7.4) at a flow rate of 0.1 mL/min. A solution of biotinylated anti-AAVx nanobody at 1 μg/μL concentration was injected onto the column with 10 μL injections until saturation was observed as measured by UV at 280 nm. As shown in FIG. 7A-7B, the biotinylated anti-AAVx nanobody was able to bind to accessible binding sites of streptavidin for both columns. There was an approximate ~14% increase in anti-AAVx nanobody binding to the crosslinked streptavidin column after accounting for differences in streptavidin coverage between the particles.

### Example 5: Biotin Endcapping of Affinity Chromatographic Columns

The ability for a column including particles as prepared in Example 3 to bind to a solution including biotin and a biotinylated antibody was determined. After packing the particles into a liquid chromatography system, the column was equilibrated with 100 mM of PBS at a flow rate of 0.1 mL/min. 10 μL injections of 1 mg/mL of anti-insulin antibody was flowed onto the column. This process was repeated for a total of ~55 injections. Effluent was monitored using a UV detector (280 nm)

The affinity chromatographic column was next used to test the impact of biotin endcapping 10 μL of a 1 mg/mL insulin sample were injected onto the column using 100 mM sodium phosphate (pH 4) at a flow rate of 0.1 mL/min for minutes 0-2 and at a flow rate of 1 mL/min for minutes 2-3. The eluent was monitored using a fluorescence detector at 280 nm excitation and 350 nm emission. The insulin was eluted from the column using 20 mM sodium phosphate (pH 2.3) and 500 mM NaCl for minutes 3-4 at 1 mL/min. The column was then equilibrated with 100 mM of PBS for minutes 4-5, after which 4 injections of 1.25 μg biotin were performed (i.e., the affinity chromatograph was endcapped with biotin, wherein the biotin can bind to unoccupied streptavidin binding sites in the column). Said unoccupied streptavidin binding sites may be present due to, for example, incomplete saturation of the column or due to steric hindrance with the affinity group.

### Example 6: One-Step Coupling of Biotin or a Biotinylated Affinity Agent to Crosslinked Streptavidin

The ability for a column including particles as prepared in Example 3 to bind to a solution including biotin and a biotinylated antibody was determined. First, the column was prepared, and the particles were functionalized with crosslinked streptavidin as described in Example 3.

Columns were washed with a mobile phase of 100 mM of PBS at a flow rate of 0.15 mL/min. with D-biotin and a biotinylated affinity agent, was injected with 2 μL injections until saturation was observed as measured by UV at 260 nm. Saturation of biotin binding sites is determined by an increase in UV absorbance at 260 nm as, without available streptavidin binding sites, biotin passes through the column and can then be detected in the eluent. As an initial test, biotinylated dT₂₅ was used as a biotinylated affinity agent. The experiment was repeated at different ratios of biotinylated dT₂₅ and free biotin.

### Example 7: Biotin Coverage in Crosslinked Streptavidin-Conjugated Particles

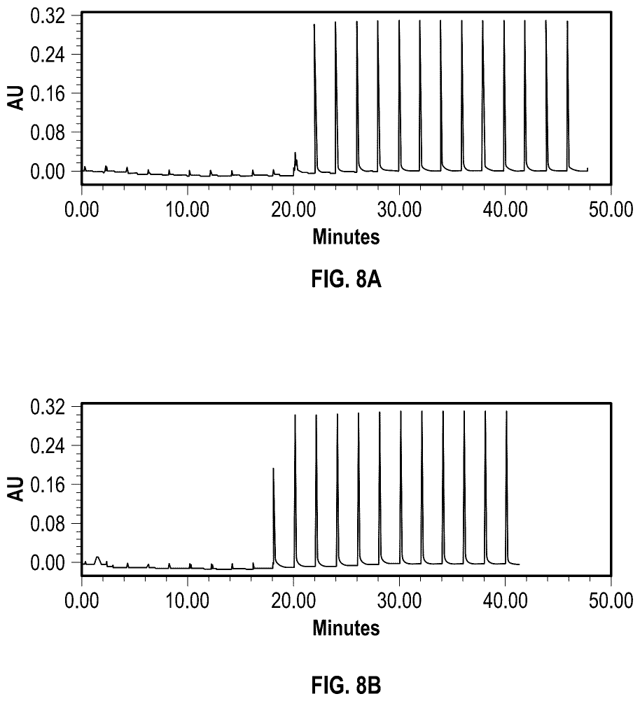

The ability of free biotin to bind to a crosslinked streptavidin-conjugated particles which has been treated with an affinity agent was investigated. First, a column including crosslinked streptavidin-conjugated particles was prepared as described in Example 3. A solution of 0.1 M of PBS and 1 nmol/L of biotin was flown through the column at a flow rate of 0.25 mL/min and an injection volume of 2 μL every 2 min. The results are shown in FIG. 8A. A negligible amount of biotin was detected in the eluent for the first 18 minutes of the experiment, indicating that biotin was primarily binding to accessible binding sites in the crosslinked streptavidin. Beginning at 20 minutes, an increase in biotin was observed in the eluent, indicating the binding sites of crosslinked streptavidin were approaching saturation. From 22 minutes onward, the absorbance of biotin in the eluent was constant, indicating that the crosslinked streptavidin was fully saturated with biotin.

A second column including crosslinked streptavidin-conjugated particles was prepared as described in Example 3. The second streptavidin column was treated with a biotinylated anti-insulin moiety to create an anti-insulin coupled crosslinked streptavidin-conjugated particles.

The anti-insulin binding efficacy was determined by first approximating the total number of accessible binding sites available for the anti-insulin (based on the coverage of the particle by crosslinked streptavidin, the density of particles in a 2.1×20 mm column, and 4 biotin binding sites per molecule of streptavidin). Then, the amount of anti-insulin associated with the crosslinked streptavidin was determined based on the injected amount of anti-insulin compared to the anti-insulin in the eluent. By comparing the amount of anti-insulin bound to streptavidin to the number of sites anti-insulin could potentially bind to, an anti-insulin coverage can be determined. For the present particles, the coverage was determined to be approximately 12%. Further coverage (i.e., more than 12%) is likely not possible due to steric hindrance of anti-insulin from occupying more binding sites in crosslinked streptavidin. Biotin was then flown through the second column under identical conditions to the first column (0.1 M of PBS, 1 nmol/μL of biotin, a flow rate of 0.25 mL/min, and an injection volume of 2 μL every 2 min). The results are shown in FIG. 8B. A negligible amount of biotin was detected in the eluent for the first 16 minutes of the experiment. Beginning at 18 minutes, there is a significant increase in biotin absorbance in the eluent, reaching saturation by the 20 minute injection (corresponding to the tenth injection of the 2 μL volume of biotin).

The reduction in binding capacity for biotin of the second column demonstrates that crosslinked streptavidin binding sites which are normally available for biotin (such as in the first column) are instead taken up by the biotinylated affinity agent, reducing the available binding sites for biotin in the second column. Critically, the reduction of biotin coverage between the two columns was determined to be approximately 12%, similar to the anti-insulin coverage in the second column.

In other words, anti-insulin by itself (likely due to steric factors) is unable to bind to all accessible binding sites in crosslinked streptavidin, which may in part lead to increased leachate during experiments. By endcapping the anti-insulin coupled crosslinked streptavidin-conjugated particles with free biotin, more binding sites in crosslinked streptavidin are occupied, thereby potentially reducing leaching. Moreover, the fact that reduction in biotin binding capacity in the second column is similar to the coverage of anti-insulin indicates that the total number of binding sites occupied in the first column and the second column are similar.

### OTHER EMBODIMENTS

Various modifications and variations of the described invention will be apparent to those skilled in the art without departing from the scope of the invention. Although the invention has been described in connection with specific embodiments, it should not be unduly limited to such specific embodiments. Indeed, various modifications of the described modes for carrying out the invention that are obvious to those skilled in the art are intended to be within the scope of the invention.

Other embodiments are in the claims.

1. An affinity chromatography material comprising:
(a) a particle comprising a polymer core and a surface material on an outer layer of the polymer core;
(b) a crosslinked streptavidin molecule conjugated to the surface material, wherein the crosslinked streptavidin molecule comprises a streptavidin molecule and a crosslinking moiety;
(c) a biotinylated affinity agent; and
(d) free biotin;
wherein the biotinylated affinity agent and free biotin are bound to binding sites of the one or more streptavidin molecules.

2. The affinity chromatography material of claim 1, wherein at least 90% of accessible binding sites of the crosslinked streptavidin molecules are bound to the biotinylated affinity agent or free biotin.

3. The affinity chromatography material of claim 2, wherein at least 95% of accessible binding sites of the crosslinked streptavidin molecules are bound with the biotinylated affinity agent or free biotin.

4. The affinity chromatography material of claim 1, wherein the molar ratio of biotinylated affinity agent to free biotin bound to the crosslinked streptavidin binding sites is a 1:1 molar ratio, a 1:3 molar ratio, a 1:5 molar ratio, a 1:8 molar ratio, a 1:10 molar ratio, a 1:15 molar ratio, a 1:20 molar ratio, a 1:25 molar ratio, a 1:30 molar ratio, a 1:35 molar ratio, a 1:40 molar ratio, a 1:45 molar ratio, or a 1:50 molar ratio.

5. The affinity chromatography material of any one of claim 1, wherein the polymer core of the particle is nonporous, the surface material is hydrophilic, and the diameter of the particle is from 1.0 μm to 10 μm.

6. The affinity chromatography material of claim 5, wherein the non-porous polymer core has a gradient composition.

7. The affinity chromatography material of claim 5, wherein the polymer core comprises divinylbenzene monomers and styrene monomers.

8. The affinity chromatography material of claim 5, wherein the hydrophilic surface is selected from the group consisting of: (3-glycidyloxypropyl) trimethoxysilane, (3-glycidyloxypropyl)triethoxysilane, polyacrylate, glycidol, glyceroltriglycidyl ether, and poly(methyl acrylate).

9. The affinity chromatography material of claim 5, wherein the crosslinked streptavidin molecule is conjugated to the hydrophilic surface via an epoxy linker.

10.-12. (canceled)

13. The affinity chromatography material of claim 1, wherein the affinity chromatography material comprises a plurality of crosslinked streptavidin molecules, wherein each crosslinked streptavidin molecule is conjugated to the surface material of the particle.

14. The affinity chromatography material of claim 1, wherein the plurality of crosslinked streptavidin molecules conjugated to the surface material provide a surface coverage on the particle of from about 2 μg/mg of particle to about 6 μg/mg of particle.

15. The affinity chromatography material of claim 1, wherein the crosslinking moiety is ethylene glycol diglycidyl ether or a poly(ethylene glycol) diglycidyl ether.

16. (canceled)

17. The affinity chromatography material of claim 15, wherein the crosslinking moiety is a poly(ethylene glycol) diglycidyl ether comprising m ethylene oxide units, wherein m is from 1 to 50.

18. (canceled)

19. An affinity chromatography column comprising the affinity chromatography material of claim 1.

20. The affinity chromatographic column of claim 19, wherein at least a portion of an interior surface of the column body is coated with an alkylsilyl material.

21.-22. (canceled)

23. The affinity chromatographic column of claim 19, wherein the column is characterized by a reduction in detectable leachate of streptavidin as determined by UV absorbance.

24. The affinity chromatographic column of claim 19, wherein the column is characterized by a leachate absorbance value of <10 mAU as measured by UV absorbance at 280 nm.

25. The affinity chromatographic column of claim 19, wherein the column is characterized by at least an 85% reduction in leachate absorbance as compared to a column that does not comprise crosslinked streptavidin.

26. The affinity chromatographic column of claim 19, wherein the column is characterized by at least an 85% reduction in leachate absorbance as compared to a column that does not comprise the biotinylated affinity agent and free biotin.

27. The affinity chromatographic column of claim 19, wherein the column is characterized by at least an 85% reduction in leachate absorbance as compared to a column that does not comprise crosslinked streptavidin, the biotinylated affinity agent, and free biotin.

28-86. (canceled)
